(19) United States
(12) Patent Application Publication
(10) Pub. No.: US 2025/0054704 A1
(43) Pub. Date: Feb. 13, 2025

(54) MULTILAYER CERAMIC ELECTRONIC COMPONENT AND MOUNTING STRUCTURE OF MULTILAYER CERAMIC ELECTRONIC COMPONENT

(71) Applicant: Murata Manufacturing Co., Ltd., Nagaokakyo-shi (JP)

(72) Inventors: Kazunori USUI, Nagaokakyo-shi (JP); Takashi SAWADA, Nagaokakyo-shi (JP)

(21) Appl. No.: 18/932,730

(22) Filed: Oct. 31, 2024

Related U.S. Application Data
(63) Continuation of application No. PCT/JP2023/016529, filed on Apr. 26, 2023.

(30) Foreign Application Priority Data
Jul. 22, 2022 (JP) 2022-117485

(51) Int. Cl. H01G 4/30; H01G 2/06; H01G 4/008; H01G 4/012; H01G 4/12

(52) U.S. Cl. CPC H01G 4/30; H01G 2/065; H01G 4/008; H01G 4/012; H01G 4/12

(57) ABSTRACT

A multilayer ceramic electronic component includes a multilayer body with laminated ceramic layers and internal electrode layers, a first and second main surface opposing each other in a lamination direction, a first and second side surface opposing each other in a width direction, a first and second end surface opposing each other in a length direction, and external electrodes. The internal electrode layers include first and second internal electrode layers alternately laminated with the ceramic layers and exposed to the first and second end surfaces and first and second side surfaces. Each of the first and second external electrodes includes a dense region, and where an area ratio of a conductive component is high and a sparse region where an area ratio of the conductive component is lower than the dense region, and the dense region is located closer to a multilayer body side than the sparse region.

### CROSS REFERENCE TO RELATED APPLICATIONS

This application is a Continuation Application of PCT Application No. PCT/JP2023/016529, filed on Apr. 26, 2023, and claims the benefit of priority to Japanese Patent Application No. 2022-117485, filed on Jul. 22, 2022. The entire contents of each application are hereby incorporated herein by reference.

### BACKGROUND OF THE INVENTION

### 1. Field of the Invention

The present invention relates to multilayer ceramic electronic components and mounting structures of multilayer ceramic electronic components.

### 2. Description of the Related Art

In recent years, as the performance of mobile phones such as smartphones increased, there has been a demand for size reduction of multilayer ceramic electronic components. In addition, since the thickness of the external electrode is also thinner, as the size of the multilayer ceramic electronic components is reduced, there is a problem in ensuring moisture resistance reliability.

For example, Japanese Unexamined Patent Application Publication No. 2022-62671 discloses a multilayer ceramic electronic component. The multilayer ceramic electronic component of Japanese Unexamined Patent Application Publication No. 2022-62671 includes a dielectric layer (ceramic layer), a ceramic body (multilayer body) including first and second internal electrodes located to be laminated on each other with the dielectric layer interposed therebetween, a first external electrode connected to the first internal electrode of the ceramic body, and a second external electrode connected to the second internal electrode of the ceramic body, in which the first external electrode includes a first base electrode layer located in contact with the ceramic body, a first glass layer located on the first base electrode layer, and a first resin electrode layer located on the first glass layer, and the second external electrode includes a second base electrode layer located in contact with the ceramic body, a second glass layer located on the second base electrode layer, and a second resin electrode layer located on the second glass layer. In Japanese Unexamined Patent Application Publication No. 2022-62671, by providing the first and second glass layers on the first and second base electrode layers and the first and second resin electrode layers on the first and second glass layers, moisture resistance reliability is ensured.

However, as in Japanese Unexamined Patent Application Publication No. 2022-62671, as external electrodes, when the first and second glass layers are provided on the first and second base electrode layers, and the first and second resin electrode layers are provided on the first and second glass layers, since the first and second glass layers and the first and second resin electrode layers have higher resistance values than that of the first and second base electrode layers, there is a problem that the insulation resistance increases.

### SUMMARY OF THE INVENTION

Example embodiments of the present invention provide multilayer ceramic electronic components that each prevent an increase in insulation resistance while ensuring moisture resistance reliability.

A multilayer ceramic electronic component according to an example embodiment of the present invention includes a multilayer body that includes a plurality of laminated ceramic layers, a plurality of internal electrode layers laminated on the ceramic layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction, and a plurality of external electrodes, in which the plurality of internal electrode layers have first internal electrode layers alternately laminated with the plurality of ceramic layers and exposed to the first end surface and the second end surface, and second internal electrode layers alternately laminated with the plurality of ceramic layers and exposed to the first side surface and the second side surface, the plurality of external electrodes have a first external electrode and a second external electrode connected to the first internal electrode layer, and a third external electrode and a fourth external electrode connected to the second internal electrode layer, each of the first external electrode and the second external electrode includes a base electrode layer, and the base electrode layer includes a dense region where an area ratio of a conductive component is high and a sparse region where an area ratio of the conductive component is lower than the area ratio of the conductive component of the dense region, and the dense region is located closer to a multilayer body side than the sparse region.

In a multilayer ceramic electronic component according to an example embodiment of the present invention, each of the first external electrode and the second external electrode includes the base electrode layer, the base electrode layer includes the dense region where the area ratio of the conductive component is high and the sparse region where the area ratio of the conductive component is lower than the area ratio of the conductive component of the dense region, and the dense region is located closer to the multilayer body side than the sparse region. Therefore, the contact property between the internal electrode layer and the conductive component in the external electrode increases, and the insulation resistance can be reduced. In addition, since the portion close to the multilayer body includes a dense region, moisture resistance reliability can be improved.

A mounting structure of a multilayer ceramic electronic component according to an example embodiment of the present invention includes a mounting substrate, and a multilayer ceramic electronic component mounted on the mounting substrate, in which the multilayer ceramic electronic component has a multilayer body including a plurality of laminated ceramic layers, a plurality of laminated internal electrode layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction, and a plurality of external electrodes, the plurality of internal electrode layers have first internal electrode layers alternately laminated with the plurality of ceramic layers and exposed to the first end surface and the second end surface, and second internal electrode layers alternately laminated with the plurality of ceramic layers and exposed to the first side surface and the second side surface, the plurality of external electrodes have a first external electrode and a second external electrode connected to the first internal electrode layer, and a third external electrode and a fourth external electrode connected to the second internal electrode layer, each of the first external electrode and the second external electrode has a base electrode layer, and the base electrode layer includes a dense region where an area ratio of a conductive component is high and a sparse region where an area ratio of the conductive component is lower than the area ratio of the conductive component of the dense region, the dense region is located closer to a multilayer body side than the sparse region, the mounting substrate has a core material of a substrate, a first connection conductor connected to the first external electrode located on the core material, a second connection conductor connected to the second external electrode located on the core material, a third connection conductor connected to the third external electrode located on the core material, and a fourth connection conductor connected to the fourth external electrode located on the core material, and in the multilayer ceramic electronic component, the first external electrode and the second external electrode which include the dense region and the sparse region are connected to an anode.

In a mounting structure of a multilayer ceramic electronic component according to an example embodiment of the present invention, a multilayer ceramic capacitor is mounted on the mounting substrate so that the second main surface opposes the substrate-side mounting surface, and the first external electrode and the second external electrode including the dense region and the sparse region are connected to the anode. Therefore, the current distance is reduced, and an increase in insulation resistance can be prevented while ensuring moisture resistance reliability.

A multilayer ceramic electronic component according to an example embodiment of the present invention includes a multilayer body that includes a plurality of laminated ceramic layers, a plurality of laminated internal electrode layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction, and a plurality of external electrodes, in which the plurality of internal electrode layers have first internal electrode layers alternately laminated with the plurality of ceramic layers and exposed to the first end surface and the second end surface, and second internal electrode layers alternately laminated with the plurality of ceramic layers and exposed to the first side surface and the second side surface, the plurality of external electrodes have a first external electrode and a second external electrode connected to the first internal electrode layer, and a third external electrode and a fourth external electrode connected to the second internal electrode layer, each of the third external electrode and the fourth external electrode has a base electrode layer, and the base electrode layer includes a dense region where an area ratio of a conductive component is high and a sparse region where an area ratio of the conductive component is lower than the area ratio of the conductive component of the dense region, and the dense region is located closer to a multilayer body side than the sparse region.

In a multilayer ceramic electronic component according to an example embodiment of the present invention, each of the third external electrode and the fourth external electrode includes the base electrode layer, the base electrode layer includes the dense region where the area ratio of the conductive component is high and the sparse region where the area ratio of the conductive component is lower than the area ratio of the conductive component of the dense region, and the dense region is located closer to the multilayer body side than the sparse region. Therefore, the contact property between the internal electrode layer and the conductive component in the external electrode increases, and the insulation resistance can be reduced. In addition, since the portion close to the multilayer body includes a dense region, moisture resistance reliability can be improved.

A mounting structure of a multilayer ceramic electronic component according to an example embodiment of the present invention includes a mounting substrate, and a multilayer ceramic electronic component mounted on the mounting substrate, in which the multilayer ceramic electronic component includes a multilayer body including a plurality of laminated ceramic layers, a plurality of laminated internal electrode layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction, and a plurality of external electrodes, the plurality of internal electrode layers have first internal electrode layers alternately laminated with the plurality of ceramic layers and exposed to the first end surface and the second end surface, and second internal electrode layers alternately laminated with the plurality of ceramic layers and exposed to the first side surface and the second side surface, the plurality of external electrodes have a first external electrode and a second external electrode connected to the first internal electrode layer, and a third external electrode and a fourth external electrode connected to the second internal electrode layer, each of the third external electrode and the fourth external electrode has a base electrode layer, and the base electrode layer includes a dense region where an area ratio of a conductive component is high and a sparse region where an area ratio of the conductive component is lower than the area ratio of the conductive component of the dense region, the dense region is located closer to a multilayer body side than the sparse region, the mounting substrate includes a core material of a substrate, a first connection conductor connected to the first external electrode located on the core material, a second connection conductor connected to the second external electrode located on the core material, a third connection conductor connected to the third external electrode located on the core material, and a fourth connection conductor connected to the fourth external electrode located on the core material, and in the multilayer ceramic electronic component, third external electrode and the fourth external electrode which include the dense region and the sparse region are connected to an anode.

In a mounting structure of a multilayer ceramic electronic component according to an example embodiment of the present invention, the multilayer ceramic capacitor is mounted on the mounting substrate so that the second main surface opposes the substrate-side mounting surface, and the third external electrode and the fourth external electrode including the dense region and the sparse region are connected to the anode. Therefore, the current distance is reduced, and an increase in insulation resistance can be prevented while ensuring moisture resistance reliability.

According to example embodiments of the present invention, it is possible to provide multilayer ceramic electronic components and mounting structures of multilayer ceramic electronic components that each prevent an increase in insulation resistance while ensuring moisture resistance reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multilayer ceramic capacitor, which is an example of a multilayer ceramic electronic component according to a first example embodiment of the present invention.

FIG. 2 is a top view illustrating the multilayer ceramic capacitor, which is an example of the multilayer ceramic electronic component according to the first example embodiment of the present invention.

FIG. 3 is a front view illustrating the multilayer ceramic capacitor, which is an example of the multilayer ceramic electronic component according to the first example embodiment of the present invention.

FIG. 4 is a cross-sectional view taken along line IV-IV according to FIG. 1.

FIG. 5 is a cross-sectional view taken along line V-V according to FIG. 1.

FIG. 6 is a cross-sectional view taken along line VI-VI according to FIG. 4.

FIG. 7 is a cross-sectional view taken along line VII-VII according to FIG. 4.

FIG. 8 is an enlarged view of a portion A according to FIG. 4.

FIG. 9 is an LT cross-sectional view illustrating an example of a mounting structure of the multilayer ceramic electronic component according to the first example embodiment of the present invention.

FIG. 10 is a WT cross-sectional view illustrating an example of the mounting structure of the multilayer ceramic electronic component according to the first example embodiment of the present invention.

FIG. 11 is an external perspective view illustrating a multilayer ceramic capacitor, which is an example of a multilayer ceramic electronic component according to a second example embodiment of the present invention.

FIG. 12 is a top view illustrating the multilayer ceramic capacitor, which is an example of the multilayer ceramic electronic component according to the second example embodiment of the present invention.

FIG. 13 is a front view illustrating the multilayer ceramic capacitor, which is an example of the multilayer ceramic electronic component according to the second example embodiment of the present invention.

FIG. 14 is a cross-sectional view taken along line XIV-XIV according to FIG. 11.

FIG. 15 is a cross-sectional view taken along line XV-XV according to FIG. 11.

FIG. 16 is a cross-sectional view taken along line XVI-XVI according to FIG. 14.

FIG. 17 is a cross-sectional view taken along line XVII-XVII according to FIG. 14.

FIG. 18 is an enlarged view of a portion B according to FIG. 14.

FIG. 19 is an LT cross-sectional view illustrating an example of the mounting structure of the multilayer ceramic electronic component according to the second example embodiment of the present invention.

FIG. 20 is a WT cross-sectional view illustrating an example of the mounting structure of the multilayer ceramic electronic component according to the second example embodiment of the present invention.

### DETAILED DESCRIPTION OF THE EXAMPLE EMBODIMENTS

### First Example Embodiment

### 1. Multilayer Ceramic Electronic Component

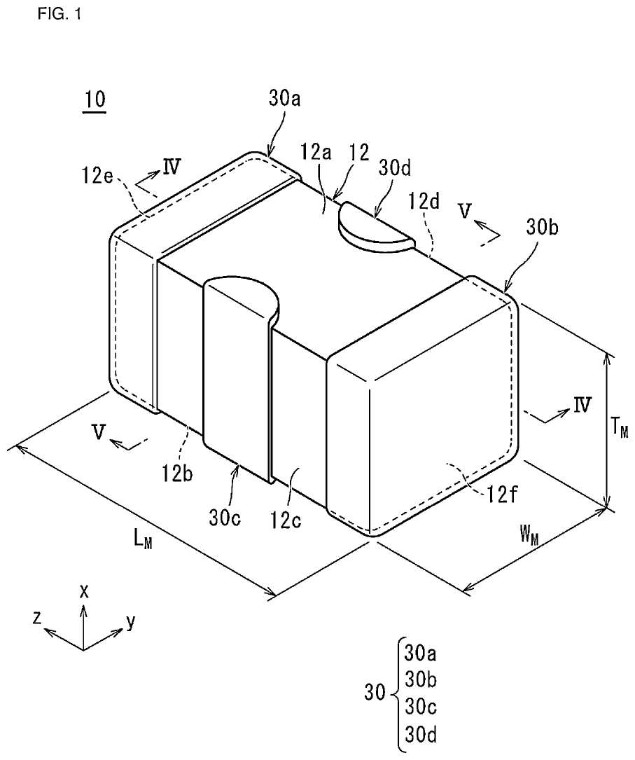

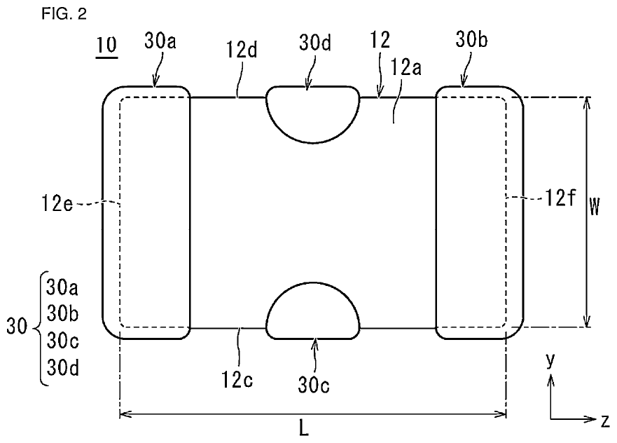

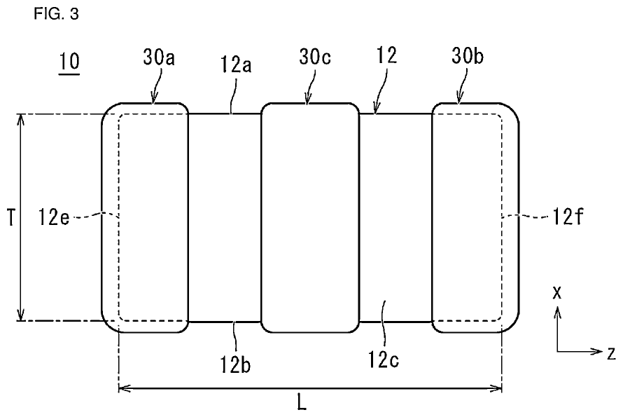

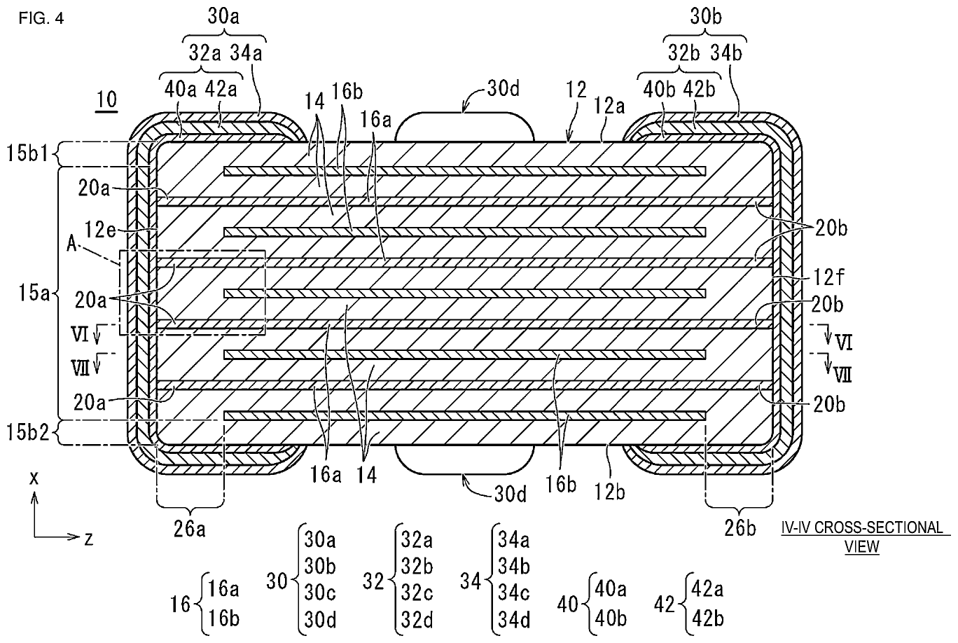

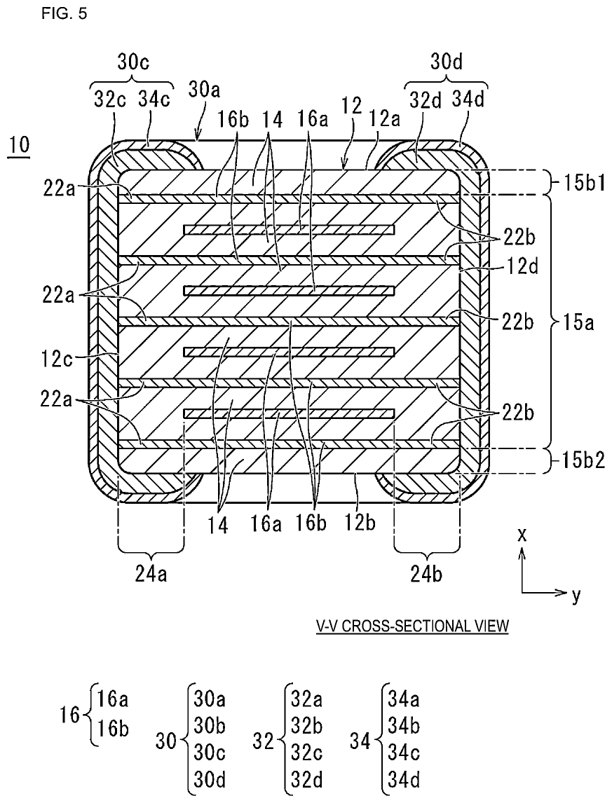

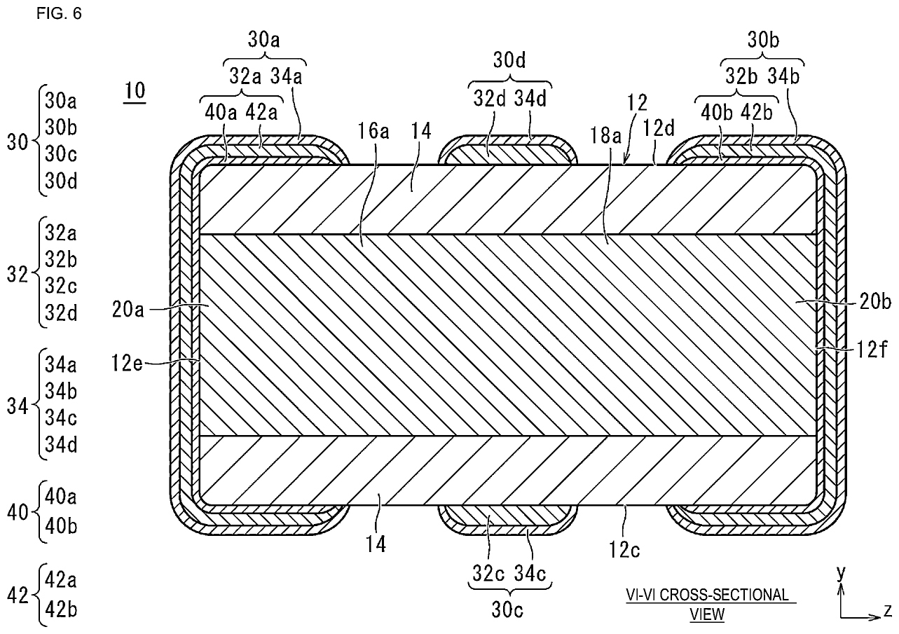

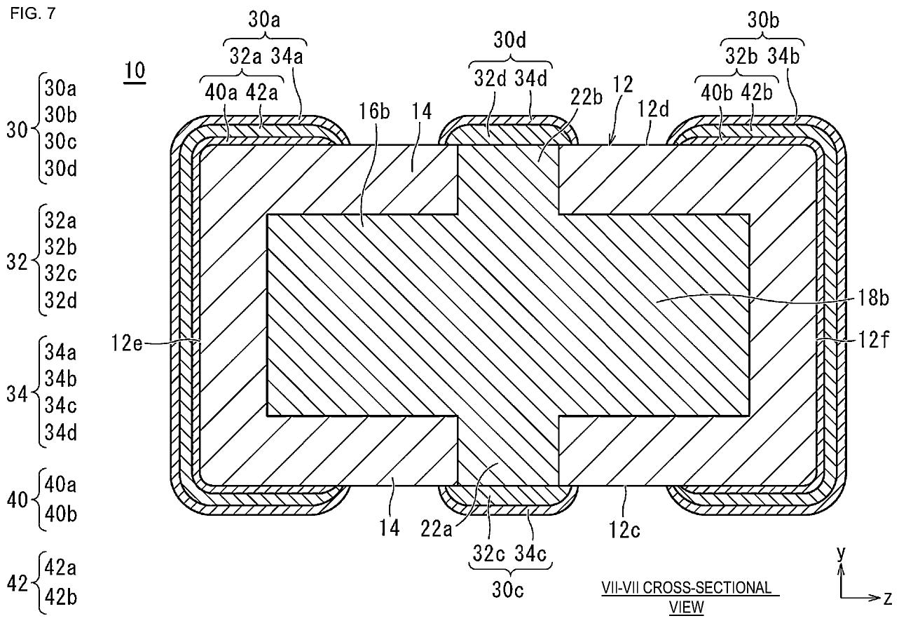

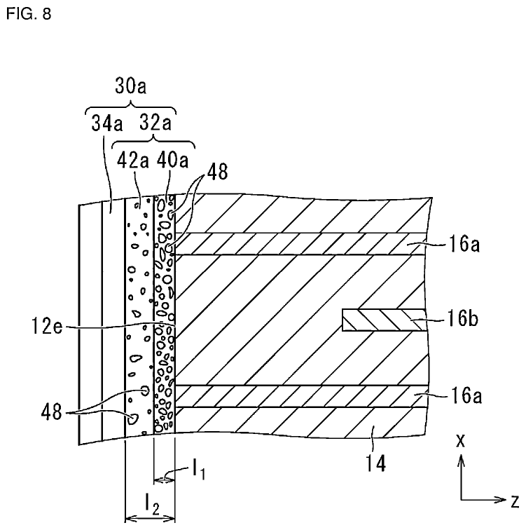

A multilayer ceramic capacitor 10, which is an example of a multilayer ceramic electronic component according to a first example embodiment of the present invention, will be described. FIG. 1 is an external perspective view illustrating a multilayer ceramic capacitor, which is an example of a multilayer ceramic electronic component according to a first example embodiment of the present invention. FIG. 2 is a top view illustrating the multilayer ceramic capacitor, which is an example of the multilayer ceramic electronic component according to the first example embodiment of the present invention. FIG. 3 is a front view illustrating the multilayer ceramic capacitor, which is an example of the multilayer ceramic electronic component according to the first example embodiment of the present invention. FIG. 4 is a cross-sectional view taken along line IV-IV according to FIG. 1. FIG. 5 is a cross-sectional view taken along line V-V according to FIG. 1. FIG. 6 is a cross-sectional view taken along line VI-VI according to FIG. 4. FIG. 7 is a cross-sectional view taken along line VII-VII according to FIG. 4. FIG. 8 is an enlarged view of a portion A according to FIG. 4.

The multilayer ceramic capacitor 10 includes a multilayer body 12 including a plurality of laminated ceramic layers 14 and a plurality of laminated internal electrode layers 16, and including a first main surface 12a and a second main surface 12b opposing each other in a lamination direction x, a first side surface 12c and a second side surface 12d opposing each other in a width direction y orthogonal to the lamination direction x, and a first end surface 12e and a second end surface 12f opposing each other in a length direction z orthogonal to the lamination direction x and the width direction y, and a plurality of external electrodes 30.

A dimension of the multilayer ceramic capacitor 10 including the multilayer body 12 and the external electrode 30 in the length direction z is defined as a dimension L_{M}. The dimension L_{M} is, for example, preferably about 0.4 mm or more and about 1.6 mm or less. A dimension of the multilayer ceramic capacitor 10 including the multilayer body 12 and the external electrode 30 in the width direction y is defined as a dimension W_{M}. The dimension W_{M} is, for example, preferably about 0.2 mm or more and about 1.0 mm or less. A dimension of the multilayer ceramic capacitor 10 including the multilayer body 12 and the external electrode 30 in the lamination direction x is defined as a dimension T_{M}. The dimension T_{M} is, for example, preferably about 0.2 mm or more and about 1.0 mm or less.

### Multilayer Body

The multilayer body 12 includes the plurality of ceramic layers 14 and the plurality of internal electrode layers 16 which are laminated. Furthermore, the multilayer body 12 includes the first main surface 12a and the second main surface 12b opposing each other in the lamination direction x, the first side surface 12c and the second side surface 12d opposing each other in the width direction y orthogonal or substantially orthogonal to the lamination direction x, and the first end surface 12e and the second end surface 12f opposing each other in the length direction z orthogonal or substantially orthogonal to the lamination direction x and the width direction y.

The multilayer body 12 preferably has a rectangular or substantially rectangular parallelepiped shape. In addition, in the multilayer body 12, it is preferable that corner portions and ridge portions are rounded. The corner portion is a portion where three adjacent surfaces of the multilayer body 12 intersect, and the ridge portion is a portion where two adjacent surfaces of the multilayer body 12 intersect. In addition, unevenness or the like may be formed on a part or all of the first main surface 12a and the second main surface 12b, the first side surface 12c and the second side surface 12d, and the first end surface 12e and the second end surface 12f.

The multilayer body 12 includes an effective layer portion 15a in which the plurality of internal electrode layers 16 are provided so as to oppose each other with the ceramic layer 14 interposed therebetween in the lamination direction x where the first main surface 12a and the second main surface 12b are connected to each other, a first outer layer portion 15b1 made from the plurality of ceramic layers 14 located between the first main surface 12a and the internal electrode layer 16 located closest to the first main surface 12a among the plurality of internal electrode layers 16, and a second outer layer portion 15b2 made from the plurality of ceramic layers 14 located between the second main surface 12b and the internal electrode layer 16 located closest to the second main surface 12b among the plurality of internal electrode layers 16.

The first outer layer portion 15b1 is located on the first main surface 12a side of the multilayer body 12, and is an aggregate of the plurality of ceramic layers 14 located between the first main surface 12a and the internal electrode layer 16 closest to the first main surface 12a.

The second outer layer portion 15b2 is located on the second main surface 12b side of the multilayer body 12, and is an aggregate of the plurality of ceramic layers 14 located between the second main surface 12b and the internal electrode layer 16 closest to the second main surface 12b.

A region interposed between the first outer layer portion 15b1 and the second outer layer portion 15b2 is the effective layer portion 15a.

The multilayer body 12 is located between one end in the width direction y of a first opposing portion 18a of a first internal electrode layer 16a and a second opposing portion 18b of a second internal electrode layer 16b, which will be described later, and the first side surface 12c, and between one end in the width direction y of a first opposing portion 18a of a first internal electrode layer 16a and a second opposing portion 18b of a second internal electrode layer 16b, which will be described later, and the second side surface 12d, and includes side portions (W gaps) 24a, and 24b of the multilayer body 12 including a first extension portion 22a and a second extension portion 22b of the second internal electrode layer 16b.

In addition, the multilayer body 12 is located between one end in the length direction z of a first opposing portion 18a of a first internal electrode layer 16a and a second opposing portion 18b of a second internal electrode layer 16b, which will be described later, and the first end surface 12e, and between one end in the length direction z of a first opposing portion 18a of a first internal electrode layer 16a and a second opposing portion 18b of a second internal electrode layer 16b, which will be described later, and the second end surface 12f, and includes end portions (L gaps) 26a, and 26b of the multilayer body 12 including a first extended portion 20a and a second extended portion 20b of the first internal electrode layer 16a.

The number of sheets of the ceramic layers 14 to be laminated is not particularly limited, but is, for example, preferably about 4 sheets or more and about 1,000 sheets or less including the first outer layer portion 15b1 and the second outer layer portion 15b2. In addition, the thickness of the ceramic layer 14 is, for example, preferably about 0.4 μm or more and about 1.0 μm or less.

The material of the ceramic layer 14 can be made of, for example, a dielectric material. As the dielectric material, for example, a dielectric ceramic having a main component such as BaTiO₃, CaTiO₃, SrTiO₃, and CaZrO₃ can be used. In addition, for example, those obtained by adding auxiliary components such as a Mn compound, a Fe compound, a Cr compound, a Co compound, and a Ni compound to these main components may be used.

The dimension of the multilayer body 12 is not particularly limited, but the dimension obtained by removing the thickness of the external electrode 30 of the present example embodiment from the dimension of the multilayer ceramic capacitor 10 is the dimension of the multilayer body 12. A dimension in the length direction z where the first end surface 12e and the second end surface 12f of the multilayer body 12 are connected is defined as a dimension L. The dimension L is, for example, preferably about 0.4 mm or longer and about 1.6 mm or shorter. A dimension in the width direction y where the first side surface 12c and the second side surface 12d of the multilayer body 12 are connected is defined as a dimension W. The dimension W is, for example, preferably about 0.2 mm or longer and about 1.0 mm or shorter. A dimension in the lamination direction x where the first main surface 12a and the second main surface 12b of the multilayer body 12 are connected is defined as a dimension T. The dimension T is, for example, preferably about 0.2 mm or longer and about 1.0 mm or shorter.

### Internal Electrode Layer

The internal electrode layer 16 includes a first internal electrode layer 16a and a second internal electrode layer 16b.

The first internal electrode layer 16a is located on the surface of the ceramic layer 14. The first internal electrode layer 16a includes a first opposing portion 18a located inside the multilayer body 12, a first extended portion 20a connected to the first opposing portion 18a and extended to the first end surface 12e, and a second extended portion 20b extended to the second end surface 12f.

The shape of the first opposing portion 18a of the first internal electrode layer 16a is not particularly limited, but is preferably a rectangular or substantially rectangular shape in a plan view. However, the corner portion may be rounded in a plan view or the corner portion may be formed diagonally in a plan view (e.g., have a tapered shape). In addition, the shape may be a tapered shape in a plan view that is inclined toward any direction.

The shapes of the first extended portion 20a and the second extended portion 20b of the first internal electrode layer 16a are not particularly limited, but are preferably rectangular or substantially rectangular shapes in a plan view. However, the corner portion may be rounded in a plan view or the corner portion may be formed diagonally in a plan view (e.g., in a tapered shape). In addition, the shape may be a tapered shape in a plan view that is inclined toward any direction.

The second internal electrode layer 16b is located on the surface of the ceramic layer 14 different from the ceramic layer 14 on which the first internal electrode layer 16a is located. The second internal electrode layer 16b includes a second opposing portion 18b that opposes the first internal electrode layer 16a, a first extension portion 22a connected to the second opposing portion 18b and extended to the first side surface 12c, a second extension portion 22b extended to the second side surface 12d.

The shape of the second opposing portion 18b of the second internal electrode layer 16b is not particularly limited, but is preferably a rectangular or substantially rectangular shape in a plan view. However, the corner portion may be rounded in a plan view or the corner portion may be formed diagonally in a plan view (e.g., have a tapered shape). In addition, the shape may be a tapered shape in a plan view that is inclined toward any direction.

The shapes of the first extension portion 22a and the second extension portion 22b of the second internal electrode layer 16b are not particularly limited, but are preferably rectangular or substantially rectangular shapes in a plan view. However, the corner portion may be rounded in a plan view or the corner portion may be formed diagonally in a plan view (e.g., have a tapered shape). In addition, the shape may be a tapered shape in a plan view that is inclined toward any direction.

The first internal electrode layer 16a and the second internal electrode layer 16b can be made of an appropriate conductive material, such as, for example, a metal such as Ni, Cu, Ag, Pd, and Au, or an alloy including at least one of these metals, such as an Ag—Pd alloy.

In addition, the number of sheets of the first internal electrode layers 16a is not particularly limited, but for example, it is preferable that the number is 1 sheet or more and 500 sheets or less. The number of sheets of the second internal electrode layers 16b is not particularly limited, but for example, it is preferable that the number is 1 sheet or more and 500 sheets or less. The number of sheets of the first internal electrode layer 16a and the second internal electrode layer 16b is preferably 2 sheets or more and 1,000 sheets or less in total.

The thickness of the first internal electrode layer 16a is not particularly limited, but is preferably, for example, about 0.4 μm or more and about 0.8 μm or less.

In addition, the thickness of the second internal electrode layer 16b is not particularly limited, but is preferably, for example, about 0.4 μm or more and about 0.8 μm or less.

In the present example embodiment, a capacitance is generated by the first opposing portion 18a of the first internal electrode layer 16a and the second opposing portion 18b of the second internal electrode layer 16b opposing each other with the ceramic layer 14 interposed therebetween, and the characteristics of the capacitor are expressed.

In a case where a piezoelectric ceramic is used as the multilayer body 12, the multilayer ceramic electronic component defines and functions as a ceramic piezoelectric element. Specific examples of piezoelectric ceramic material include, for example, a lead zirconate titanate (PZT)-based ceramic material, and the like.

In addition, in a case where a semiconductor ceramic is used as the multilayer body 12, the multilayer ceramic electronic component defines and functions as a thermistor element. Specific examples of the semiconductor ceramic material include, for example, a spinel-based ceramic material, and the like.

In addition, in a case where a magnetic ceramic is used as the multilayer body 12, the multilayer ceramic electronic component defines and functions as an inductor element. In addition, in the case of defining and functioning as an inductor element, the internal electrode layer becomes a coiled conductor. Specific examples of magnetic ceramic material include, for example, a ferrite ceramic material, and the like.

That is, by appropriately changing the material and structure of the multilayer body 12, the multilayer ceramic electronic component according to the present example embodiment can suitably define and function not only as the multilayer ceramic capacitor 10 but also as a ceramic piezoelectric element, a thermistor element, or an inductor element.

### External Electrode

The external electrode 30 includes the plurality of external electrodes 30 connected to the first internal electrode layer 16a and the second internal electrode layer 16b. The external electrode 30 includes a first external electrode 30a, a second external electrode 30b, a third external electrode 30c, and a fourth external electrode 30d.

The first external electrode 30a is located on the first end surface 12e and is connected to the first internal electrode layer 16a. In addition, the first external electrode 30a may also be located on a part of the first main surface 12a, a portion of the second main surface 12b, a portion of the first side surface 12c, and a portion of the second side surface 12d.

The second external electrode 30b is located on the second end surface 12f and is connected to the first internal electrode layer 16a. In addition, the second external electrode 30b may also be located on a portion of the first main surface 12a, a portion of the second main surface 12b, a portion of the first side surface 12c, and a portion of the second side surface 12d.

The third external electrode 30c is located on the first side surface 12c and is connected to the second internal electrode layer 16b. In addition, the third external electrode 30c may be located on a portion of the first main surface 12a and a portion of the second main surface 12b.

The fourth external electrode 30d is located on the second side surface 12d and is connected to the second internal electrode layer 16b. In addition, the fourth external electrode 30d may be located on a portion of the first main surface 12a and a portion of the second main surface 12b.

Each of the first external electrode 30a, the second external electrode 30b, the third external electrode 30c, and the fourth external electrode 30d preferably include a base electrode layer 32 and a plating layer 34.

In other words, the first external electrode 30a preferably includes a first base electrode layer 32a and a first plating layer 34a. The second external electrode 30b preferably includes a second base electrode layer 32b and a second plating layer 34b. The third external electrode 30c preferably includes a third base electrode layer 32c and a third plating layer 34c. The fourth external electrode 30d preferably includes a fourth base electrode layer 32d and a fourth plating layer 34d.

Furthermore, the first base electrode layer 32a of the first external electrode 30a, and the second base electrode layer 32b of the second external electrode 30b each have a dense region 40 where the area ratio of the conductive component 48 is high, and a sparse region 42 where the area ratio of the conductive component 48 is lower than that of the dense region 40.

More specifically, the first base electrode layer 32a includes a dense region 40a where the area ratio of the conductive component 48 is high, and a sparse region 42a where the area ratio of the conductive component 48 is lower than that of the dense region 40a. In addition, the second base electrode layer 32b includes a dense region 40b where the area ratio of the conductive component 48 is high, and a sparse region 42b where the area ratio of the conductive component 48 is lower than that of the dense region 40b. The dense region 40 includes the dense region 40a of the first base electrode layer 32a and the dense region 40b of the second base electrode layer 32b. Similarly, the sparse region 42 includes the sparse region 42a of the first base electrode layer 32a and the sparse region 42b of the second base electrode layer 32b.

In addition, the dense region 40 is located closer to the multilayer body 12 side than the sparse region 42. Since the dense region 40 is located closer to the multilayer body 12 side than the sparse region 42, the contact property between the first internal electrode layer 16a and the conductive component 48 in the first external electrode 30a or the second external electrode 30b is increased, leading to a reduction in insulation resistance. In addition, the fact that the dense region 40 where the area ratio of the conductive component 48 is high is included in a portion close to the multilayer body 12 also leads to improvement in moisture resistance reliability.

Furthermore, the area ratio of the conductive component 48 to the area of the dense region 40 is, for example, preferably about 80% or higher and about 85% or lower. When the area ratio of the conductive component 48 with respect to the area of the dense region 40 is lower than about 80%, since the area ratio of voids with respect to the dense region 40 where the area ratio of the conductive component 48 is high increases, this leads to a decrease in moisture resistance reliability. In addition, when the area ratio of the conductive component 48 with respect to the area of the dense region 40 is higher than about 858, since the content of the non-conductive component that ensures connection with the multilayer body 12 decreases, the risk of peeling off the first external electrode 30a or the second external electrode 30b increases.

In addition, the area ratio of the conductive component 48 with respect to the area of the sparse region 42 is, for example, preferably about 75% or higher and about 80% or lower. When the area ratio of the conductive component 48 with respect to the area of the sparse region 42 is lower than about 758, since the area ratio of voids with respect to the sparse region 42 where the area ratio of the conductive component 48 is low increases, this leads to a decrease in moisture resistance reliability. In addition, when the area ratio of the conductive component 48 with respect to the area of the sparse region 42 is higher than about 80%, the compressive stress of the sparse region 42 increases, which may lead to a structural defect.

The thickness l₁ of the dense region 40 in the length direction z of the multilayer body 12 is, for example, preferably about 30% or more and about 50% or less of the thickness l₂ of the first base electrode layer 32a and the second base electrode layer 32b in the length direction z of the multilayer body 12. When the thickness l₁ of the dense region 40 in the length direction z of the multilayer body 12 is smaller than about 30% of the thickness l₂ of the first base electrode layer 32a and the second base electrode layer 32b in the length direction z of the multilayer body 12, since the area ratio of the sparse region 42 with respect to the dense region 40 increases, this leads to a decrease in moisture resistance reliability. In addition, when the thickness l₁ of the dense region 40 in the length direction z of the multilayer body 12 is larger than about 50% of the thickness l₂ of the first base electrode layer 32a and the second base electrode layer 32b in the length direction z of the multilayer body 12, since the area ratio of the sparse region 42 with respect to the dense region 40 decreases, the stress relaxation effect cannot be sufficiently obtained, which may lead to a structural defect.

Here, in an example of a method of measuring the area ratio of the conductive component 48 in the dense region 40 and the sparse region 42 of the first base electrode layer 32a and the second base electrode layer 32b, first, cross-sectional polishing is performed up to about ½ of a dimension W_{M} in a width direction y of the multilayer ceramic capacitor 10 (about ½ LT cross-section). Next, measurement is performed with a secondary electron image or a reflected electron image of a scanning electron microscope (SEM). The measurement portion of the dense region 40 is about ½ of the multilayer body 12 in the lamination direction x and a 30% portion from the first end surface 12e and second end surface 12f of the thickness (l₂) of the first base electrode layer 32a and the second base electrode layer 32b in the length direction z of the multilayer body 12, on the polished surface. In addition, the measurement portion of the sparse region 42 is ½ of the multilayer body 12 in the lamination direction x and an 80% portion from the first end surface 12e and second end surface 12f of the thickness (l₂) of the first base electrode layer 32a and the second base electrode layer 32b in the length direction z of the multilayer body 12, on the polished surface. Next, the conductive portion and the non-conductive portion are preferably binarized to calculate the area ratio of the conductive component 48 using HALCON of MVTec company.

The base electrode layer 32 includes, for example, at least one of a fired layer, a conductive resin layer, a thin film layer, and the like. In a case where the dense region 40 and the sparse region 42 are provided in the first base electrode layer 32a and the second base electrode layer 32b, it is preferable that the first base electrode layer 32a and the second base electrode layer 32b include at least one selected from the fired layer and the conductive resin layer.

First, a case where the base electrode layer 32 is formed with a fired layer will be described. The fired layer includes a metal component and a glass component. The glass component preferably includes at least one of, for example, B, Si, Ba, Mg, Al, Li, and the like. In addition, as the metal component of the fired layer, for example, at least one of Cu, Ni, Ag, Pd, Ag—Pd alloy, Au, and the like is included. In the case of the fired layer, the metal component defines and functions as the conductive component 48. Furthermore, the fired layer may include a plurality of layers.

The fired layer is obtained by applying a conductive paste including a glass component and a metal component to the multilayer body 12 and firing the conductive paste. The fired layer may be a layer obtained by simultaneously firing a multilayer chip including the internal electrode layer 16 and the ceramic layer 14 and a conductive paste applied to the multilayer chip, or may be a layer obtained by firing a multilayer chip including the internal electrode layer 16 and the ceramic layer 14 to obtain the multilayer body 12, and then applying a conductive paste and firing the multilayer body 12. In a case where the multilayer chip including the internal electrode layer 16 and the ceramic layer 14, and the conductive paste applied to the multilayer chip are simultaneously fired, it is preferable to form the fired layer by adding a ceramic component instead of the glass component, or by adding both components.

The thickness of the first fired layer and the second fired layer in the length direction z connecting the first end surface 12e and the second end surface 12f (thickness at the center of the end surface) is preferably, for example, about 5 μm or more and about 30 μm or less, at the central portion in the lamination direction x connecting the first main surface 12a and the second main surface 12b of the first fired layer and the second fired layer located on the first end surface 12e and the second end surface 12f.

In addition, in a case where the base electrode layer (fired layer) is also provided at a portion of the first main surface 12a or a portion of the second main surface 12b, the thickness of the first fired layer and the second fired layer in the lamination direction x connecting the first main surface 12a and the second main surface 12b is preferably, for example, about 5 μm or more and about 10 μm or less, at the central portion in the length direction z connecting the first end surface 12e and second end surface 12f of the first fired layer and the second fired layer located on the first main surface 12a or the second main surface 12b.

Next, a case where the base electrode layer 32 is formed with a conductive resin layer will be described. Although the conductive resin layer is located on the fired layer so as to cover the fired layer, the conductive resin layer may be directly located on the multilayer body 12 without providing the fired layer. In addition, the conductive resin layer may completely cover the fired layer or may cover a portion of the fired layer. Furthermore, the conductive resin layer may include a plurality of layers.

The conductive resin layer includes a heat-solidification resin and a metal. Since the conductive resin layer includes a heat-solidification resin, for example, the conductive resin layer has more flexibility than a fired layer made of a plating film or a fired product of a conductive paste. Therefore, even in a case where the multilayer ceramic capacitor 10 is subjected to a physical shock or an impact due to a thermal cycle, the conductive resin layer defines and functions as a buffer layer and can prevent cracks in the multilayer ceramic capacitor 10.

As the metal included in the conductive resin layer, Ag, Cu, Ni, Sn, Bi, or an alloy including these metals can be used, for example. In addition, a metal powder obtained by coating the surface of the metal powder with Ag can also be used. When using a metal powder coated with Ag on the surface, for example, it is preferable to use Cu, Ni, Sn, Bi, or an alloy powder thereof as the metal powder. The reason for using the conductive metal powder of Ag as the conductive metal is that since Ag has the lowest specific resistance among metals, Ag is suitable for electrode materials, and since Ag is a noble metal, Ag does not oxidize and has high weather resistance. In addition, this is because the base metal can be made inexpensive while maintaining the above characteristics of Ag. In the case of a conductive resin layer, a conductive metal functions as the conductive component 48.

Furthermore, as the metal included in the conductive resin layer, for example, Cu or Ni subjected to antioxidant treatment can also be used. As the metal included in the conductive resin layer, for example, a metal powder obtained by coating the surface of a metal powder with Sn, Ni, or Cu can also be used. When using a metal powder obtained by coating the surface of, for example, a metal powder with Sn, Ni, or Cu, it is preferable to use Ag, Cu, Ni, Sn, Bi, or an alloy powder thereof as the metal powder.

The metal included in the conductive resin layer is mainly responsible for the conductivity of the conductive resin layer. Specifically, an electric conduction path is formed inside the conductive resin layer when the conductive fillers come into contact with each other.

As the metal included in the conductive resin layer, a metal having a spherical shape or a flat shape can be used, but it is preferable that a spherical metal powder and a flat metal powder are mixed and used.

As the resin of the conductive resin layer, for example, various known heat-solidification resins such as epoxy resin, phenol resin, urethane resin, silicone resin, and polyimide resin can be used. Among these resins, an epoxy resin having good heat resistance, moisture resistance, close contact, and the like is one of the most appropriate resins.

In addition, it is preferable that the conductive resin layer includes a curing agent together with the heat-solidification resin. As a curing agent, for example, in a case where an epoxy resin is used as a base resin, various known compounds such as phenol-based, amine-based, acid anhydride-based, imidazole-based, active ester-based, and amide-imide-based compounds can be used as a curing agent for the epoxy resin.

The thickest portion of the conductive resin layer is preferably, for example, about 5 μm or more and about 30 μm or less.

Either or each of the third external electrode 30c and the fourth external electrode 30d may include a thin film layer as the base electrode layer 32 on the surface of the multilayer body 12. In a case where a thin film layer is provided as the base electrode layer 32, the thin film layer is formed by a thin film forming method such as, for example, a sputtering method or an evaporation method, and is a layer of, for example, about 1 μm or less on which metal particles are deposited.

### Plating Layer

The plating layer 34 includes a first plating layer 34a located so as to cover the first base electrode layer 32a, a second plating layer 34b located so as to cover the second base electrode layer 32b, a third plating layer 34c located so as to cover the third base electrode layers 32c, and a fourth plating layer 34d located so as to cover the fourth base electrode layer 32d.

The plating layer 34 includes, for example, at least one selected from Cu, Ni, Sn, Ag, Pd, Ag—Pd alloy, Au, and the like.

In addition, the plating layer 34 may include a plurality of layers. It is preferable to have a two-layer structure including, for example, the Ni plating, and Sn plating in this order. The Ni plating layer can prevent the base electrode layer 32 from being eroded by the solder when mounting the multilayer ceramic capacitor 10. In addition, the Sn plating layer can improve the wettability of the solder when mounting the multilayer ceramic capacitor 10 and can be easily mounted.

In addition, the thickness per layer of the plating layer 34 is, for example, preferably about 4 μm or more and about 10 μm or less.

The plating layer 34 of either or each of the third external electrode 30c and the fourth external electrode 30d may be directly provided on the surface of the multilayer body 12. In other words, the multilayer ceramic capacitor 10 may have a structure including the plating layer 34 directly electrically connected to the second internal electrode layer 16b. In such a case, the plating layer 34 may be directly formed after a catalyst is located on the surface of the multilayer body 12 as a pretreatment.

In a case where the plating layer 34 is directly provided on the multilayer body 12, since it can be converted to a reduced height, that is, a reduced height or the thickness of the multilayer body 12, that is, the thickness of the effective layer portion 15a, the degree of freedom in designing a thin chip can be improved.

In a case where the plating layer 34 is directly provided on the multilayer body 12, it is preferable that the plating layer 34 includes a lower layer plating electrode provided on the surface of the multilayer body 12 and an upper layer plating electrode provided on the surface of the lower layer plating electrode.

It is preferable that each of the lower layer plating electrode and the upper layer plating electrode includes, for example, at least one metal selected from Cu, Ni, Sn, Pb, Au, Ag, Pd, Bi, Zn, or the like, or an alloy including the metal.

In addition, for example, in a case where the first internal electrode layer 16a and the second internal electrode layer 16b are preferably formed using Ni, the lower layer plating electrode is preferably formed using Cu having good coupling properties with Ni. The upper layer plating electrode may be formed as necessary, and each of the third external electrode 30c and the fourth external electrode 30d may include only the lower layer plating electrode.

In a case where the plating layer 34 is directly provided on the multilayer body 12, the plating layer 34 may include the upper layer plating electrode as the outermost layer, or other plating electrodes may be provided on the surface of the upper layer plating electrode.

In a case where the plating layer 34 is directly provided on the multilayer body 12, the thickness per layer of the plating layer 34 is, for example, preferably about 1 μm or more and about 15 μm or less.

In a case where the plating layer 34 is directly provided on the multilayer body 12, the plating layer 34 preferably does not include glass. In addition, the metal ratio per unit volume of the plating layer 34 is, for example, preferably about 99% by volume or more.

According to the multilayer ceramic capacitor 10 illustrated in FIG. 1, each of the first external electrode 30a and the second external electrode 30b includes base electrode layers 32a and 32b, the base electrode layers 32a and 32b include the dense region 40 where the area ratio of the conductive component 48 is high, and the sparse region 42 where the area ratio of the conductive component 48 is lower than that of the dense region 40, and the dense region 40 is located closer to the multilayer body 12 than the sparse region 42. As a result, the contact property between the internal electrode layer 16 and the conductive component 48 in the external electrode 30 increases, and the insulation resistance can be reduced. In addition, by including the dense region 40 at the portion close to the multilayer body 12, the moisture resistance reliability can be improved.

According to the multilayer ceramic capacitor 10 illustrated in FIG. 1, the thickness l₁ of the dense region 40 in the length direction z of the multilayer body 12 is, for example, preferably about 30% or more and about 50% or less of the thickness l₂ of the first base electrode layer 32a and the second base electrode layer 32b in the length direction z of the multilayer body 12. As a result, the contact property between the internal electrode layer 16 and the conductive component 48 in the external electrode 30 increases, the insulation resistance can be reduced, and the moisture resistance reliability can also be improved.

According to the multilayer ceramic capacitor 10 illustrated in FIG. 1, the area ratio of the conductive component 48 in the dense region 40 is, for example, preferably about 80% or higher and about 85% or lower with respect to the area of the dense region 40. As a result, the contact property between the internal electrode layer 16 and the conductive component 48 in the external electrode 30 further increases, the insulation resistance can be reduced, and the moisture resistance reliability can also be improved.

According to the multilayer ceramic capacitor 10 illustrated in FIG. 1, the area ratio of the conductive component 48 in the sparse region 42 is, for example, preferably about 75% or higher and about 80% or lower with respect to the area of the sparse region 42. As a result, moisture resistance reliability can be further improved.

### 2. Mounting Structure of Multilayer Ceramic Electronic Component

Subsequently, a mounting structure 60 of the multilayer ceramic capacitor 10, which is an example of the multilayer ceramic electronic component according to the first example embodiment of the present invention, will be described.

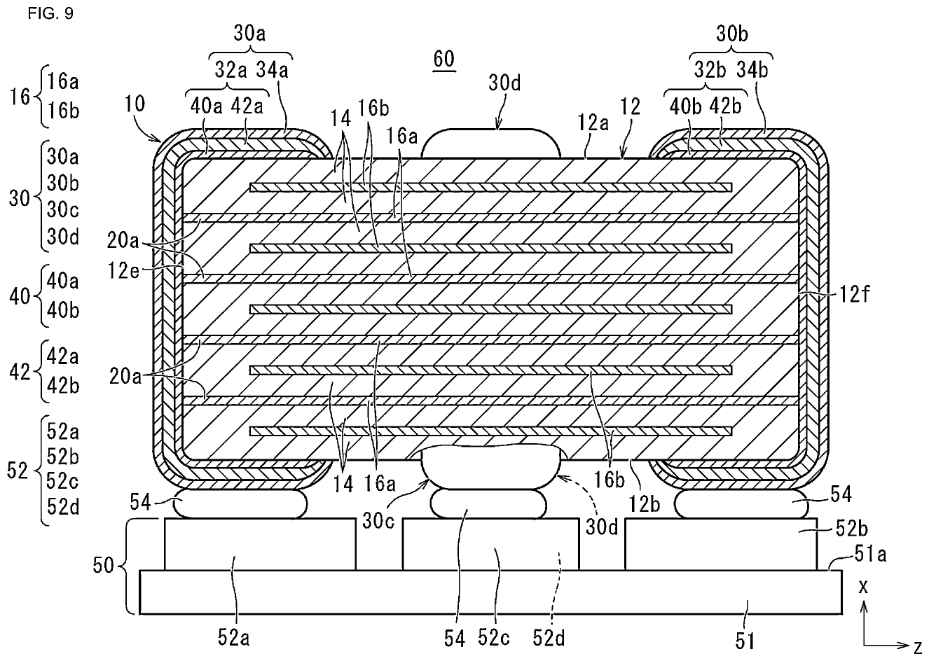

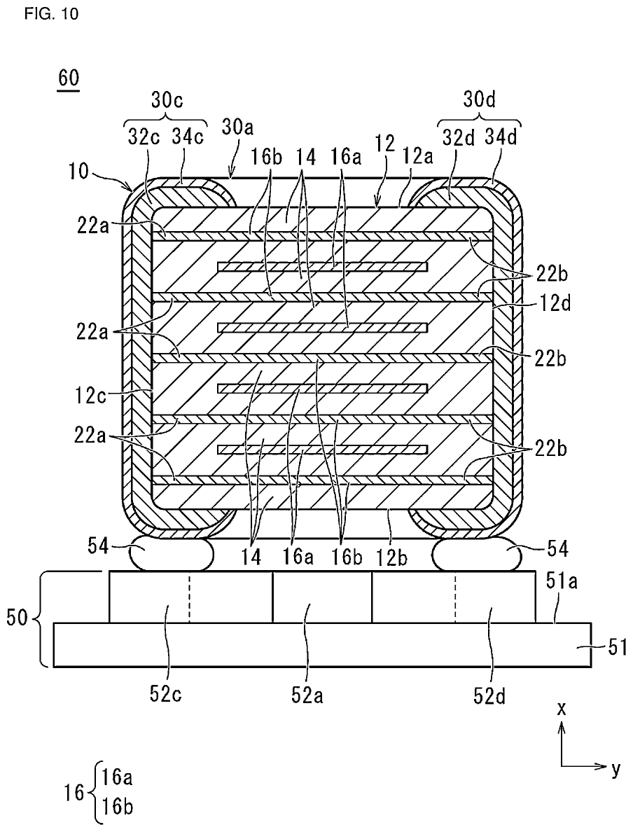

As illustrated in FIGS. 9 and 10, the mounting structure 60 of a multilayer ceramic capacitor according to the present example embodiment includes the multilayer ceramic capacitor 10 according to the present example embodiment and a mounting substrate 50. The mounting substrate 50 includes a core material 51 of the substrate and a conductor land 52. The core material 51 of the substrate includes, for example, a substrate made of a material obtained by impregnating a base material obtained by mixing a glass cloth (cloth) and a glass nonwoven fabric with an epoxy resin or a polyimide resin, or a ceramic substrate manufactured by firing a sheet made of a mixture of ceramics and glass. The core material 51 of the substrate may be configured as a substrate made of a single layer or a substrate formed by laminating a plurality of layers.

The thickness of the core material 51 of the substrate is not particularly limited, but for example, it is preferably about 200 μm or more and about 800 μm or less.

One main surface of the core material 51 of the substrate constitutes a substrate-side mounting surface 51a on which the conductor land 52 is located and which defines and functions as a mounting surface of the multilayer ceramic capacitor 10.

The conductor land 52 includes a first conductor land 52a, a second conductor land 52b, a third conductor land 52c, and a fourth conductor land 52d.

The first conductor land 52a is a portion that is electrically connected to and mechanically coupled to the first external electrode 30a of the multilayer ceramic capacitor 10 by the bonding material 54. The second conductor land 52b is a portion that is electrically connected to and mechanically coupled to the second external electrode 30b of the multilayer ceramic capacitor 10 by the bonding material 54. The third conductor land 52c is a portion that is electrically connected to and mechanically coupled to the third external electrode 30c of the multilayer ceramic capacitor 10 by the bonding material 54. The fourth conductor land 52d is a portion that is electrically connected to and mechanically coupled to the fourth external electrode 30d of the multilayer ceramic capacitor 10 by the bonding material 54.

The conductor land 52 may be provided on the main surface of the core material 51 of the substrate opposite to the substrate-side mounting surface 51a.

The material of the conductor land 52 is not particularly limited, but for example, a metal such as copper, gold, palladium, and platinum can be used. In addition, the thickness of the conductor land 52, that is, the dimension in the lamination direction x is not particularly limited, but is preferably, for example, about 20 μm or more and about 200 μm or less. As the bonding material 54, for example, a high heat-resistant epoxy-based adhesive agent can be used.

In the above description, the mounting substrate 50 corresponds to the mounting substrate of the present invention. The core material 51 of the substrate corresponds to the core material of the substrate of the present invention. The substrate-side mounting surface 51a corresponds to the mounting surface of the present invention. A plurality of conductor lands 52 correspond to a plurality of connection conductors of the present invention. However, in addition to the land, the connection conductor of the present invention is not limited by other uses, functions, shapes, names, and the like, as long as the connection conductor is a conductor that is provided between the multilayer ceramic capacitor and the mounting substrate and can electrically connect both.

The mounting structure 60 of the multilayer ceramic capacitor illustrated in FIGS. 9 and 10 is mounted on the mounting substrate 50 so that the second main surface 12b of the multilayer ceramic capacitor 10 faces the substrate-side mounting surface 51a. Furthermore, the first external electrode 30a and the second external electrode 30b including the dense region 40 and the sparse region 42 are connected to the anode. As a result, the current distance is reduced, and an increase in insulation resistance can be prevented while ensuring moisture resistance reliability.

### 3. Method of Manufacturing Multilayer Ceramic Electronic Component

Hereinafter, a method of manufacturing the multilayer ceramic capacitor 10, which is an example of the multilayer ceramic electronic component according to the first example embodiment of the present invention, will be described.

First, a dielectric sheet and a conductive paste for an internal electrode are prepared. The dielectric sheet and the conductive paste for the internal electrode include a binder and a solvent. As the binder and the solvent, known ones can be used.

Next, a conductive paste for the internal electrode is printed on the dielectric sheet in a predetermined pattern by, for example, screen printing or gravure printing. As a result, a dielectric sheet in which the pattern of the first internal electrode layer is formed, and a dielectric sheet in which the pattern of the second internal electrode layer is formed are prepared. More specifically, a screen plate for printing the first internal electrode layer and a screen plate for printing the second internal electrode layer are separately prepared, and the internal electrode layer 16 of the present invention can be printed using a printing machine that can print each of two types of screen plates separately. Here, a portion that becomes the effective layer portion 15a is formed by laminating the sheets on which the first internal electrode layer and the second internal electrode layer are printed such that a desired structure is obtained. In the present example embodiment, the internal electrode pattern is printed by using a screen plate.

Next, by laminating a predetermined number of dielectric sheets on which the pattern of the internal electrode layer is not printed, a portion that becomes the first outer layer portion 15b1 on the first main surface 12a side is formed. Thereafter, the portion that becomes the effective layer portion 15a prepared above is laminated, and a predetermined number of dielectric sheets on which the patterns of the internal electrode layer are not printed are laminated on the portion that becomes the effective layer portion 15a, so that a portion that becomes the second outer layer portion 15b2 on the second main surface 12b side is formed. As a result, a multilayer sheet is prepared.

Next, the multilayer sheet is pressed in a lamination direction by a device such as, for example, an isostatic press to prepare a multilayer block.

Subsequently, the multilayer block is cut into a predetermined size, and a multilayer chip is cut out. At this time, a corner portion and a ridge portion of the multilayer chip may be rounded by barrel polishing or the like.

Next, the multilayer chip is fired to prepare a multilayer body 12. The firing temperature depends on the material of the ceramic or the internal electrode, but is, for example, preferably about 900° C. or higher and about 1,400° C. or lower.

A first base electrode layer 32a of the first external electrode 30a and a second base electrode layer 32b of the second external electrode 30b are formed on the first end surface 12e and the second end surface 12f of the multilayer body 12 obtained by firing. In addition, a third base electrode layer 32c of the third external electrode 30c and a fourth base electrode layer 32d of the fourth external electrode 30d are formed on the first side surface 12c and the second side surface 12d of the multilayer body 12 obtained by firing.

In a case where a fired layer is formed as the base electrode layer 32, a conductive paste including a glass component and a metal is applied, and then a firing treatment is performed to form the base electrode layer 32.

More specifically, first, the third base electrode layer 32c of the third external electrode 30c and the fourth base electrode layer 32d of the fourth external electrode 30d are formed on the first side surface 12c and the second side surface 12d of the multilayer body 12 obtained by firing.

Here, various methods can be used as the method of forming the third base electrode layer 32c and the fourth base electrode layer 32d. For example, a method of applying a conductive paste by extruding the conductive paste from a slit can be used. In the case of this method, by increasing the extrusion amount of the conductive paste, the third base electrode layer 32c and the fourth base electrode layer 32d can be formed not only on the first side surface 12c and the second side surface 12d but also on a portion of the first main surface 12a and a portion of the second main surface 12b.

In addition, the base electrode layers can be formed by using a roller transfer method. In the case of the roller transfer method, when the third base electrode layer 32c and the fourth base electrode layer 32d are formed not only on the first side surface 12c and the second side surface 12d but also on a portion of the first main surface 12a and a portion of the second main surface 12b, by increasing the pressing pressure during roller transfer, the third base electrode layer 32c and the fourth base electrode layer 32d can be formed on a portion of the first main surface 12a and a portion of the second main surface 12b.

Next, the first base electrode layer 32a of the first external electrode 30a and the second base electrode layer 32b of the second external electrode 30b are formed on the first end surface 12e and the second end surface 12f of the multilayer body 12 obtained by firing. At this time, the conductive paste that becomes the dense region 40 is applied to the first end surface 12e and the second end surface 12f of the multilayer body 12. Next, the conductive paste that becomes the sparse region 42 is applied so as to cover a part or all of the dense region 40 formed above. Thereafter, the base electrode layer 32 is fired at a firing temperature of, for example, about 700° C. or higher and about 900° C. or lower for a firing time of about 10 minutes or higher and about 60 minutes or lower. At this time, the atmosphere is preferably one-digit reduction to ten-digit oxidation when viewed at the equilibrium oxygen partial pressure of Ni/NiO. Here, the conductive paste that becomes the dense region 40 has a higher Cu ratio than that of the conductive paste that becomes the sparse region 42, so that the dense region 40 and the sparse region 42 are formed.

Here, various methods can be used as the methods of forming the first base electrode layer 32a and the second base electrode layer 32b. For example, by using a method such as dipping, the first base electrode layer 32a and the second base electrode layer 32b can be formed so as to extend not only to the first end surface 12e and the second end surface 12f but also to a portion of the first main surface 12a and a portion of the second main surface 12b, and a portion of the first side surface 12c and a portion of the second side surface 12d.

In the present example embodiment, the first base electrode layer 32a and the second base electrode layer 32b are fired after the third base electrode layer 32c and the fourth base electrode layer 32d are fired, but the first base electrode layer 32a and the second base electrode layer 32b, and the third base electrode layer 32c and the fourth base electrode layer 32d may be simultaneously fired.

In a case where the base electrode layer 32 is formed with a conductive resin layer, the conductive resin layer can be formed by the following method. The conductive resin layer may be formed on the surface of the fired layer, or may be directly formed alone on the multilayer body without forming a fired layer.

As a method of forming the conductive resin layer, a conductive resin paste including a heat-solidification resin and a metal component is applied on the fired layer or the multilayer body, and heat treatment is performed at a temperature of 250° C. or higher and 550° C. or lower to thermally solidify the resin and form a conductive resin layer. The atmosphere at the time of the heat treatment at this time is, for example, preferably an Ne atmosphere. In addition, in order to prevent the resin from scattering and to prevent various metal components from being oxidized, the oxygen concentration is, for example, preferably reduced to about 100 ppm or less.

As a method of applying the conductive resin paste, similar to the method of forming the base electrode layer 32 with a fired layer, for example, the base electrode layer 32 can be formed by using a method of applying the conductive paste by extruding the conductive paste from a slit or a roller transfer method.

Thereafter, a plating layer 34 is formed on the base electrode layer 32 and the surface of the multilayer body 12 as necessary. In the present example embodiment, the plating layer 34 is formed on the surface of the base electrode layer 32. More specifically, a Ni plating layer and a Sn plating layer are formed on the base electrode layer 32. When performing the plating treatment, any one of electrolytic plating and electroless plating may be employed. However, electroless plating requires pretreatment with a catalyst or the like in order to improve the plating deposition rate, which has the disadvantage of complicating the process. Therefore, it is normally preferable to employ electrolytic plating.

As described above, the multilayer ceramic capacitor 10 described in FIG. 1 can be manufactured.

### Second Example Embodiment

### 1. Multilayer Ceramic Electronic Component

Subsequently, a multilayer ceramic capacitor 110, which is an example of a multilayer ceramic electronic component according to a second example embodiment of the present invention, will be described.

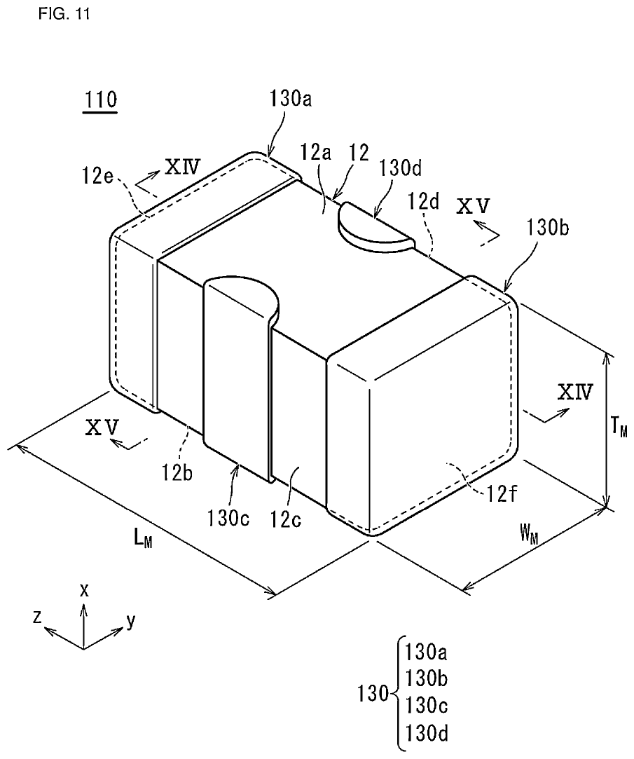

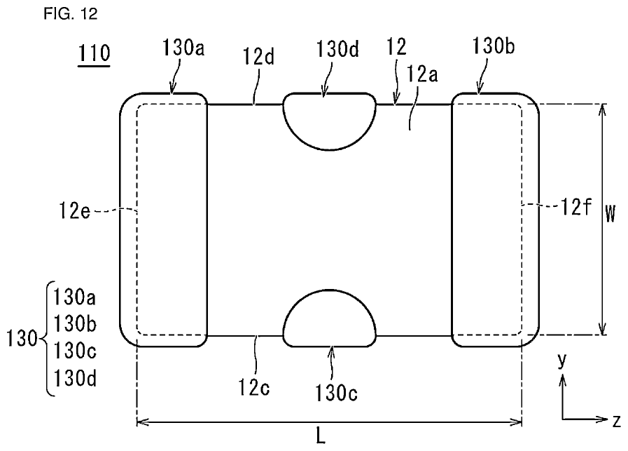

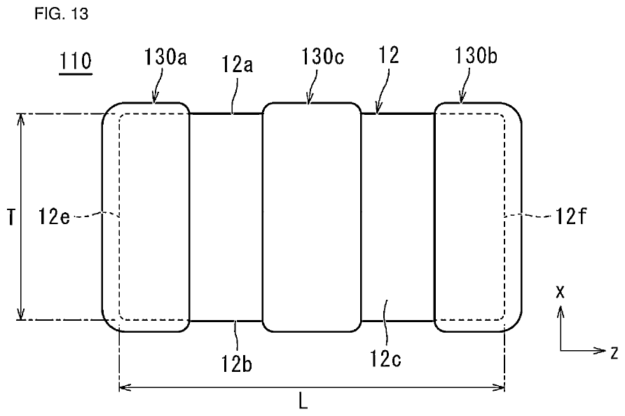

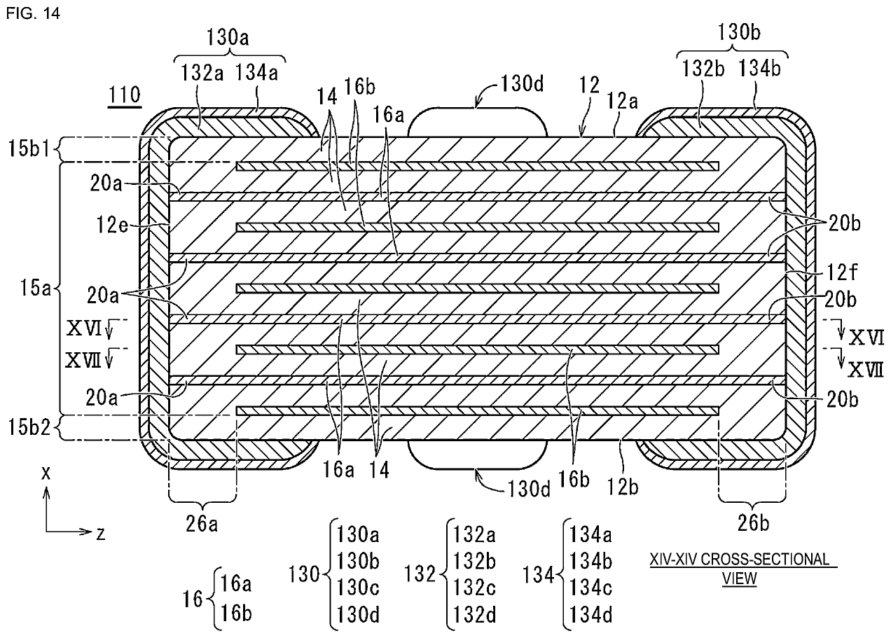

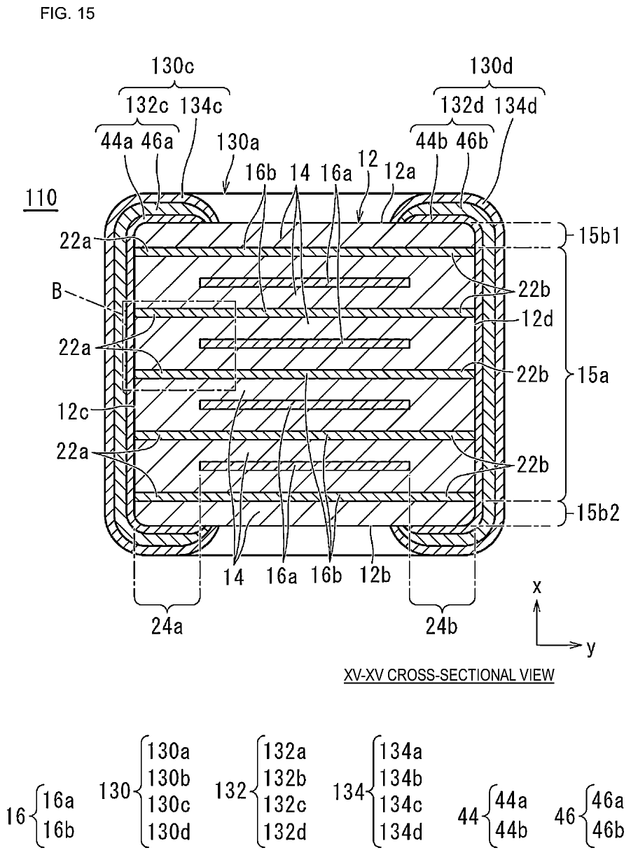

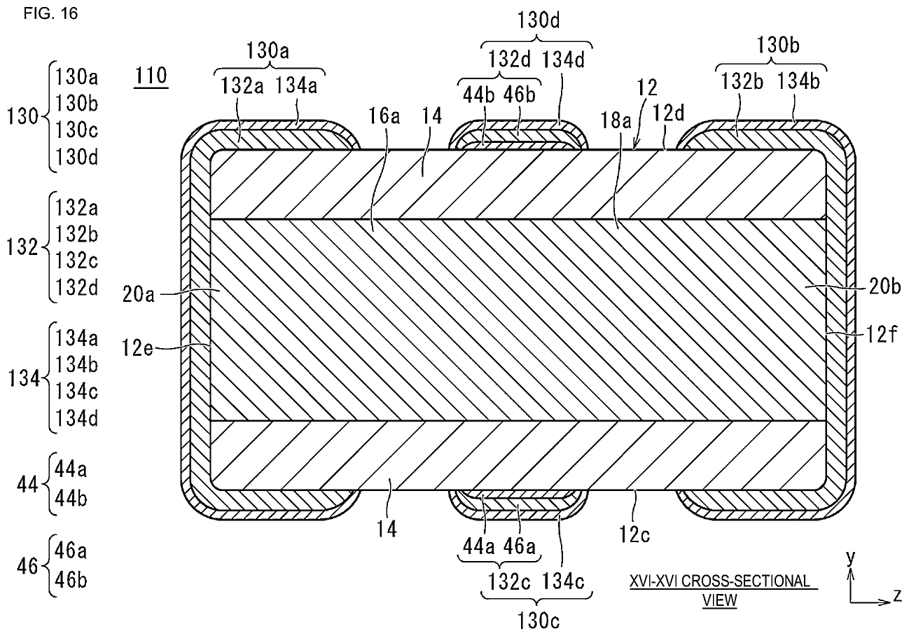

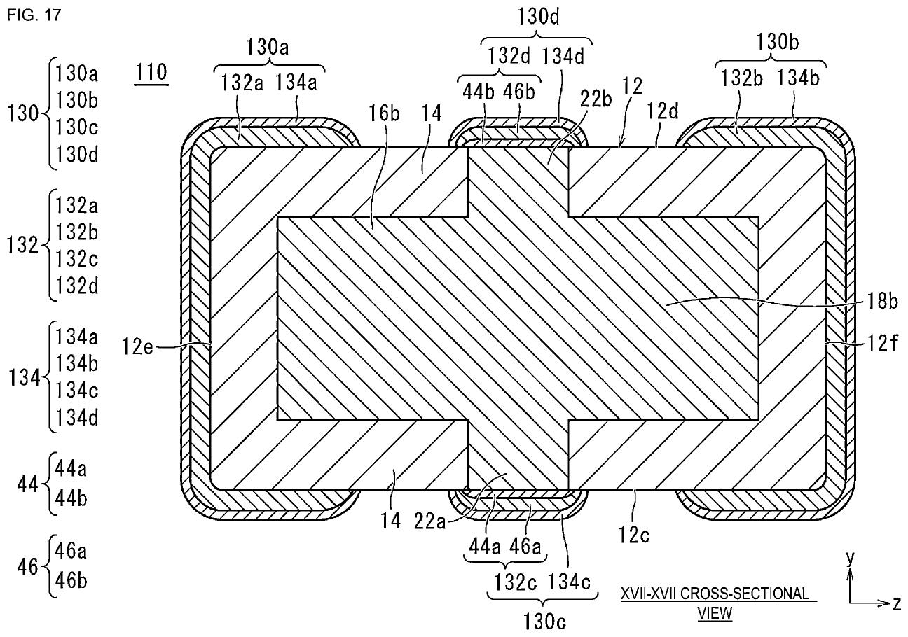

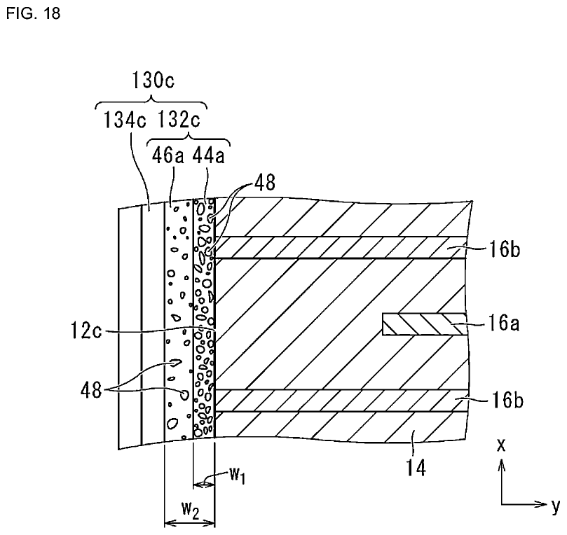

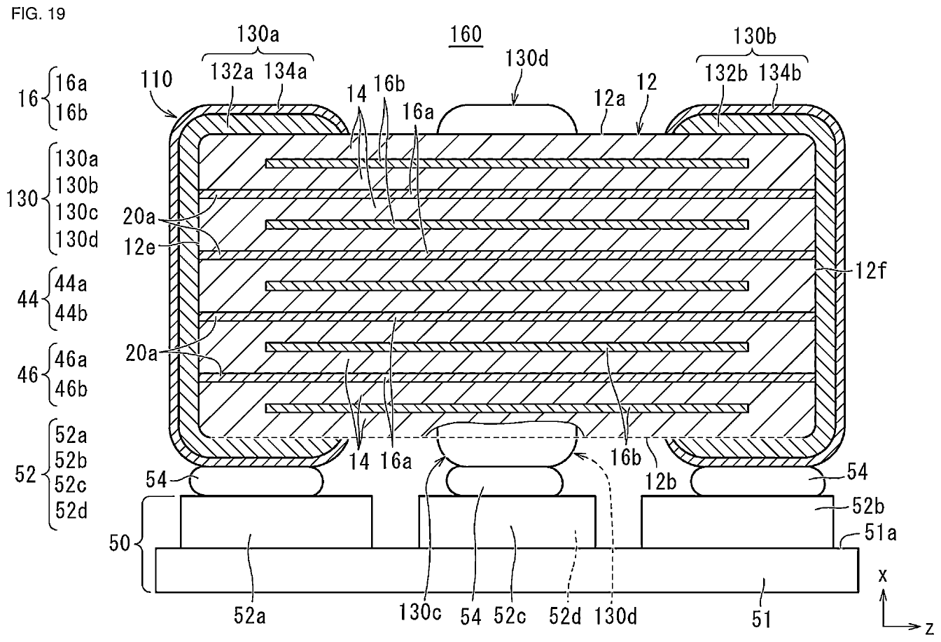

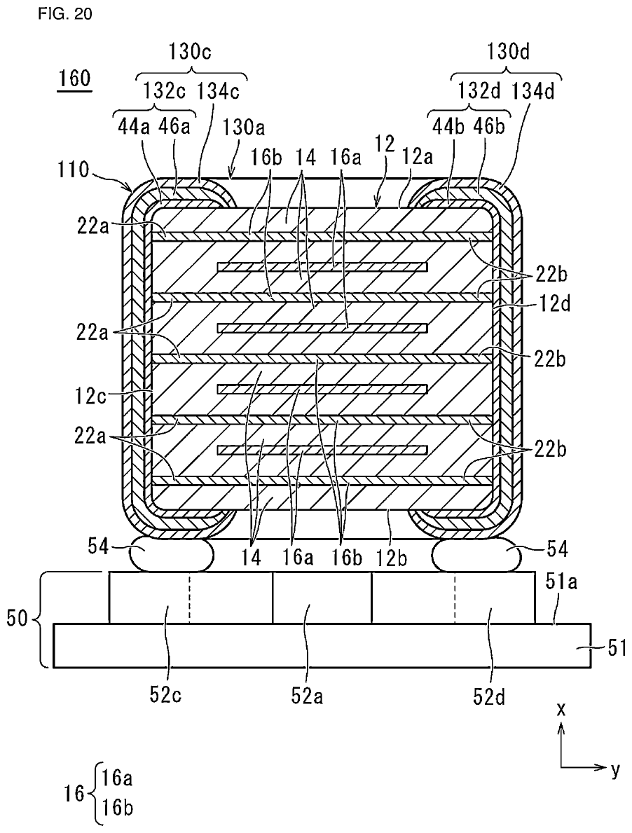

FIG. 11 is an external perspective view illustrating a multilayer ceramic capacitor, which is an example of a multilayer ceramic electronic component according to a second example embodiment of the present invention. FIG. 12 is a top view illustrating the multilayer ceramic capacitor, which is an example of the multilayer ceramic electronic component according to the second example embodiment of the present invention. FIG. 13 is a front view illustrating the multilayer ceramic capacitor, which is an example of the multilayer ceramic electronic component according to the second example embodiment of the present invention. FIG. 14 is a cross-sectional view taken along line XIV-XIV according to FIG. 11. FIG. 15 is a cross-sectional view taken along line XV-XV according to FIG. 11. FIG. 16 is a cross-sectional view taken along line XVI-XVI according to FIG. 14. FIG. 17 is a cross-sectional view taken along line XVII-XVII according to FIG. 14. FIG. 18 is an enlarged view of a portion B according to FIG. 14. FIG. 19 is an LT cross-sectional view illustrating an example of the mounting structure of the multilayer ceramic electronic component according to the second example embodiment of the present invention. FIG. 20 is a WT cross-sectional view illustrating an example of the mounting structure of the multilayer ceramic electronic component according to the second example embodiment of the present invention. However, the same reference numerals are attached to the configuration that is the same as or corresponding to the first example embodiment, and the detailed description of the configuration and operation in common with the first example embodiment is omitted.

The multilayer ceramic capacitor 110 includes a multilayer body 12 including a plurality of laminated ceramic layers 14 and a plurality of laminated internal electrode layers 16, and including a first main surface 12a and a second main surface 12b opposing each other in a lamination direction x, a first side surface 12c and a second side surface 12d opposing each other in a width direction y orthogonal or substantially orthogonal to the lamination direction x, and a first end surface 12e and a second end surface 12f opposing each other in a length direction z orthogonal or substantially orthogonal to the lamination direction x and the width direction y, and a plurality of external electrodes 130.

### External Electrode

The external electrode 130 includes the plurality of external electrodes 130 connected to the first internal electrode layer 16a and the second internal electrode layer 16b. The external electrode 130 includes a first external electrode 130a, a second external electrode 130b, a third external electrode 130c, and a fourth external electrode 130d.

The first external electrode 130a is located on the first end surface 12e and is connected to the first internal electrode layer 16a. In addition, the first external electrode 130a may also be located on a portion of the first main surface 12a, a portion of the second main surface 12b, a portion of the first side surface 12c, and a portion of the second side surface 12d.

The second external electrode 130b is located on the second end surface 12f and is connected to the first internal electrode layer 16a. In addition, the second external electrode 130b may also be located on a portion of the first main surface 12a, a portion of the second main surface 12b, a portion of the first side surface 12c, and a portion of the second side surface 12d.

The third external electrode 130c is located on the first side surface 12c and is connected to the second internal electrode layer 16b. In addition, the third external electrode 130c may be located on a portion of the first main surface 12a and a portion of the second main surface 12b.

The fourth external electrode 130d is located on the second side surface 12d and is connected to the second internal electrode layer 16b. In addition, the fourth external electrode 130d may be located on a portion of the first main surface 12a and a portion of the second main surface 12b.

Each of the first external electrode 130a, the second external electrode 130b, the third external electrode 130c, and the fourth external electrode 130d preferably include a base electrode layer 132 and a plating layer 134.

In other words, the first external electrode 130a preferably includes a first base electrode layer 132a and a first plating layer 134a. The second external electrode 130b preferably includes a second base electrode layer 132b and a second plating layer 134b. The third external electrode 130c preferably includes a third base electrode layer 132c and a third plating layer 134c. The fourth external electrode 130d preferably includes a fourth base electrode layer 132d and a fourth plating layer 134d.

In addition, the third base electrode layer 132c of the third external electrode 130c, and the fourth base electrode layer 132d of the fourth external electrode 130d each preferably include a dense region 44 where the area ratio of the conductive component 48 is high and a sparse region 46 where the area ratio of the conductive component 48 is lower than that of the dense region 44.

More specifically, the third base electrode layer 132c includes a dense region 44a where the area ratio of the conductive component 48 is high and a sparse region 46a where the area ratio of the conductive component 48 is lower than that of the dense region 44a. In addition, the fourth base electrode layer 132d includes a dense region 44b where the area ratio of the conductive component 48 is high and a sparse region 46b where the area ratio of the conductive component 48 is lower than that of the dense region 44b. The dense region 44 includes the dense region 44a of the third base electrode layer 132c and the dense region 44b of the fourth base electrode layer 132d. Similarly, the sparse region 46 includes the sparse region 46a of the third base electrode layer 132c and the sparse region 46b of the fourth base electrode layer 132d.

In addition, the dense region 44 is located closer to the multilayer body 12 side than the sparse region 46. Since the dense region 44 is located closer to the multilayer body 12 side than the sparse region 46, the contact property between the second internal electrode layer 16b and the conductive component 48 in the third external electrode 130c or the fourth external electrode 130d is increased, leading to a reduction in insulation resistance. In addition, the fact that the dense region 44 where the area ratio of the conductive component 48 is high is included in a portion close to the multilayer body 12 also leads to improvement in moisture resistance reliability.

Furthermore, the area ratio of the conductive component 48 to the area of the dense region 44 is, for example, preferably about 80% or higher and about 85% or lower. When the area ratio of the conductive component 48 with respect to the area of the dense region 44 is lower than about 80%, since the area ratio of voids with respect to the dense region 44 where the area ratio of the conductive component 48 is high increases, this leads to a decrease in moisture resistance reliability. In addition, when the area ratio of the conductive component 48 with respect to the area of the dense region 44 is higher than about 85%, since the content of the non-conductive component that ensures connection with the multilayer body 12 decreases, the risk of peeling off the third external electrode 130c or the fourth external electrode 130d increases.

In addition, the area ratio of the conductive component 48 with respect to the area of the sparse region 46 is, for example, preferably about 75% or higher and about 80% or lower. When the area ratio of the conductive component 48 with respect to the area of the sparse region 46 is lower than about 75%, the area ratio of voids with respect to the sparse region 46 where the area ratio of the conductive component 48 is low increases, this leads to a decrease in moisture resistance reliability. In addition, when the area ratio of the conductive component 48 with respect to the area of the sparse region 46 is higher than about 80%, the compressive stress of the sparse region 46 increases, which may lead to a structural defect.

The thickness w₁ of the dense region 44 in the width direction y of the multilayer body 12 is, for example, preferably about 30% or more and about 50% or less of the thickness w₂ of the third base electrode layer 132c and the fourth base electrode layer 132d in the width direction y of the multilayer body 12. When the thickness w₁ of the dense region 44 in the width direction y of the multilayer body 12 is smaller than about 30% of the thickness w₂ of the third base electrode layer 132c and the fourth base electrode layer 132d in the width direction y of the multilayer body 12, since the area ratio of the sparse region 46 with respect to the dense region 44 increases, this leads to a decrease in moisture resistance reliability. In addition, when the thickness w₁ of the dense region 44 in the width direction y of the multilayer body 12 is larger than about 50% of the thickness w₂ of the third base electrode layer 132c and the fourth base electrode layer 132d in the width direction y of the multilayer body 12, since the area ratio of the sparse region 46 with respect to the dense region 44 decreases, the stress relaxation effect cannot be sufficiently obtained, which may lead to a structural defect.

In addition, in a method of measuring the area ratio of the conductive component 48 in the dense region 44 and the sparse region 46 of the third base electrode layer 132c and the fourth base electrode layer 132d, first, cross-sectional polishing is performed up to about ½ of a dimension L_{M} in a length direction z of the multilayer ceramic capacitor 110 (about ½ WT cross-section). Next, measurement is performed with a secondary electron image or a reflected electron image of a scanning electron microscope (SEM). The measurement portion of the dense region 44 is about ½ of the multilayer body 12 in the lamination direction x and a 30% portion of the thickness (w₂) of the third base electrode layer 132c and the fourth base electrode layer 132d in the width direction y of the multilayer body 12, on the polished surface. In addition, the measurement portion of the sparse region 46 is about ½ of the multilayer body 12 in the lamination direction x and an 80% portion of the thickness (w₂) of the third base electrode layer 132c and the fourth base electrode layer 132d in the width direction y of the multilayer body 12, on the polished surface. Next, the conductive portion and the non-conductive portion are binarized to calculate the area ratio of the conductive component 48 using, for example, HALCON of MVTec company.

According to the multilayer capacitor 110 illustrated in FIG. 11, each of the third external electrode 130c and the fourth external electrode 130d include base electrode layers 132c and 132d, the base electrode layers 132c and 132d include the dense region 44 where the area ratio of the conductive component 48 is high, and the sparse region 46 where the area ratio of the conductive component 48 is lower than that of the dense region 44, and the dense region 44 is located closer to the multilayer body 12 than the sparse region 46. As a result, the contact property between the internal electrode layer 16 and the conductive component 48 in the external electrode 130 increases, and the insulation resistance can be reduced. In addition, by including the dense region 44 at the portion close to the multilayer body 12, the moisture resistance reliability can be improved.

### 2. Mounting Structure of Multilayer Ceramic Electronic Component

Subsequently, a mounting structure 160 of the multilayer ceramic capacitor 110, which is an example of the multilayer ceramic electronic component according to the second example embodiment of the present invention, will be described. The same reference numerals are attached to the configuration that is the same as or corresponding to the first example embodiment, and the detailed description of the configuration and operation in common with the first example embodiment is omitted.

A mounting structure 160 of the multilayer ceramic capacitor according to the present example embodiment includes a multilayer ceramic capacitor 110 according to the present example embodiment and a mounting substrate 50, as illustrated in FIGS. 19 and 20.

The mounting structure 160 of the multilayer ceramic capacitor illustrated in FIGS. 19 and 20 is mounted on the mounting substrate 50 so that the second main surface 12b of the multilayer ceramic capacitor 110 faces the substrate-side mounting surface 51a. Furthermore, the third external electrode 130c and the fourth external electrode 130d including the dense region 44 and the sparse region 46 are connected to the anode. As a result, the current distance is reduced, and an increase in insulation resistance can be prevented while ensuring moisture resistance reliability.

### 3. Method of Manufacturing Multilayer Ceramic Electronic Component

Hereinafter, a method of manufacturing the multilayer ceramic capacitor 110, which is an example of the multilayer ceramic electronic component according to the second example embodiment of the present invention, will be described. The same reference numerals are attached to the configuration that is the same as or corresponding to the first example embodiment, and the detailed description of the configuration and operation in common with the first example embodiment is omitted.

First, a multilayer body 12 is prepared. A first base electrode layer 132a of the first external electrode 130a and a second base electrode layer 132b of the second external electrode 130b are formed on the first end surface 12e and the second end surface 12f of the multilayer body 12 obtained by firing. In addition, a third base electrode layer 132c of the third external electrode 130c and a fourth base electrode layer 132d of the fourth external electrode 130d are formed on the first side surface 12c and the second side surface 12d of the multilayer body 12 obtained by firing.

In a case where a fired layer is formed as the base electrode layer 132, a conductive paste including a glass component and a metal is applied, and then a firing treatment is performed to form the base electrode layer 132.

More specifically, first, the third base electrode layer 132c of the third external electrode 130c and the fourth base electrode layer 132d of the fourth external electrode 130d are formed on the first side surface 12c and the second side surface 12d of the multilayer body 12 obtained by firing. At this time, the conductive paste that becomes the dense region 44 is applied to the first side surface 12c and the second side surface 12d of the multilayer body 12. Thereafter, the conductive paste that becomes the sparse region 46 is applied so as to cover a part or all of the dense region 44 formed above. The third base electrode layer 132c and the fourth base electrode layer 132d are fired at a firing temperature of, for example, about 700° C. or higher and about 900° C. or lower for a firing time of about 10 minutes or higher and about 60 minutes or lower. The atmosphere at this time is preferably one-digit reduction to ten-digit oxidation when viewed at the equilibrium oxygen partial pressure of Ni/NiO. In addition, the conductive paste that becomes the dense region 44 has a higher Cu ratio than that of the conductive paste that becomes the sparse region 46, so that the dense region 44 and the sparse region 46 are formed.

Here, various methods can be used as the methods of forming the third base electrode layer 132c and the fourth base electrode layer 132d. For example, a method of applying a conductive paste by extruding the conductive paste from a slit can be used. In the case of this method, by increasing the extrusion amount of the conductive paste, the third base electrode layer 132c and the fourth base electrode layer 132d can be formed not only on the first side surface 12c and the second side surface 12d but also on a portion of the first main surface 12a and a portion of the second main surface 12b.

In addition, the base electrode layers can be formed by using a roller transfer method, for example. In the case of the roller transfer method, when the base electrode layer 132 is formed not only on the first side surface 12c and the second side surface 12d but also on a portion of the first main surface 12a and a portion of the second main surface 12b, by increasing the pressing pressure during roller transfer, the third base electrode layer 132c and the fourth base electrode layer 132d can be formed on a portion of the first main surface 12a and a portion of the second main surface 12b.

Next, the first base electrode layer 132a of the first external electrode 130a and the second base electrode layer 132b of the second external electrode 130b are formed on the first end surface 12e and the second end surface 12f of the multilayer body 12 obtained by firing.

Here, various methods can be used as the methods of forming the first base electrode layer 132a and the second base electrode layer 132b. For example, by using a method such as dipping, the first base electrode layer 132a and the second base electrode layer 132b can be formed so as to extend not only to the first end surface 12e and the second end surface 12f but also to a portion of the first main surface 12a and a portion of the second main surface 12b, and a portion of the first side surface 12c and a portion of the second side surface 12d.

In the present example embodiment, the first base electrode layer 132a and the second base electrode layer 132b are fired after the third base electrode layer 132c and the fourth base electrode layer 132d are fired, but the first base electrode layer 132a and the second base electrode layer 132b, and the third base electrode layer 132c and the fourth base electrode layer 132d may be simultaneously fired.

In a case where the base electrode layer 132 is formed with a conductive resin layer, the conductive resin layer can be formed by the following method. The conductive resin layer may be formed on the surface of the fired layer, or may be directly formed alone on the multilayer body without forming a fired layer.

As a method of forming the conductive resin layer, a conductive resin paste including a heat-solidification resin and a metal component is applied on the fired layer or the multilayer body, and heat treatment is performed at a temperature of, for example, about 250° C. or higher and about 550° C. or lower to thermally solidify the resin and form a conductive resin layer. The atmosphere at the time of the heat treatment at this time is, for example, preferably an Ne atmosphere. In addition, in order to prevent the resin from scattering and to prevent various metal components from being oxidized, the oxygen concentration is, for example, preferably reduced to about 100 ppm or less.

As a method of applying the conductive resin paste, similar to the method of forming the base electrode layer 132 with a fired layer, for example, the base electrode layer 132 can be formed by using a method of applying the conductive paste by extruding the conductive paste from a slit or a roller transfer method.

Thereafter, a plating layer 134 is formed on the base electrode layer 132 and the surface of the multilayer body 12 as necessary. In the present example embodiment, the plating layer 134 is formed on the surface of the base electrode layer 132. More specifically, for example, a Ni plating layer and a Sn plating layer are formed on the base electrode layer 132. When performing the plating treatment, any one of electrolytic plating and electroless plating may be employed. However, electroless plating requires pretreatment with a catalyst or the like in order to improve the plating deposition rate, which has the disadvantage of complicating the process. Therefore, it is normally preferable to employ electrolytic plating.

As described above, the multilayer ceramic capacitor 110 described in FIG. 11 can be manufactured.

### Modified Example

In the first example embodiment, the dense region 40 and the sparse region 42 are included in the first base electrode layer 32a of the first external electrode 30a and the second base electrode layer 32b of the second external electrode 30b, and the present invention is not limited thereto. In addition, in the second example embodiment, the dense region 44 and the sparse region 46 are included in the third base electrode layer 132c of the third external electrode 130c and the fourth base electrode layer 132d of the fourth external electrode 130d, and the present invention is not limited thereto. That is, the dense regions and the sparse regions may be included in the first base electrode layer of the first external electrode, the second base electrode layer of the second external electrode, the third base electrode layer of the third external electrode, and the fourth base electrode layer of the fourth external electrode.

As described above, the example embodiment of the present invention is disclosed in the above description, but the present invention is not limited thereto.

That is, various changes in mechanism, shape, material, quantity, position, disposition, or the like can be made to the example embodiments and each modified example described above without departing from the scope of the technical idea and object of the present invention.

### INDUSTRIAL APPLICABILITY

Example embodiments of the present invention relate to the multilayer ceramic electronic component, and can be used as the multilayer ceramic electronic component that can prevent an increase in insulation resistance while ensuring moisture resistance reliability.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of laminated ceramic layers, a plurality of laminated internal electrode layers, a first main surface and a second main surface opposing each other in a lamination direction, a first side surface and a second side surface opposing each other in a width direction orthogonal or substantially orthogonal to the lamination direction, and a first end surface and a second end surface opposing each other in a length direction orthogonal or substantially orthogonal to the lamination direction and the width direction; and
a plurality of external electrodes; wherein
the plurality of internal electrode layers include:
first internal electrode layers alternately laminated with the plurality of ceramic layers and exposed to the first end surface and the second end surface; and
second internal electrode layers alternately laminated with the plurality of ceramic layers and exposed to the first side surface and the second side surface;
the plurality of external electrodes include:
a first external electrode and a second external electrode connected to the first internal electrode layer; and
a third external electrode and a fourth external electrode connected to the second internal electrode layer;
each of the first external electrode and the second external electrode includes a base electrode layer, and the base electrode layer includes a dense region where an area ratio of a conductive component is high and a sparse region where an area ratio of the conductive component is lower than the area ratio of the conductive component of the dense region; and
the dense region is located closer to a multilayer body side than the sparse region.

2. The multilayer ceramic electronic component according to claim 1, wherein a thickness of the dense region in the length direction of the multilayer body is about 30% or higher and about 50% or lower of a thickness of the first base electrode layer and the second base electrode layer in the length direction of the multilayer body.

3. The multilayer ceramic electronic component according to claim 1, wherein an area ratio of the conductive component in the dense region is about 80% or higher and about 85% or lower with respect to an area of the dense region.

4. The multilayer ceramic electronic component according to claim 1, wherein an area ratio of the conductive component in the sparse region is about 75% or higher and about 80% or lower with respect to an area of the sparse region.

5. A mounting structure of a multilayer ceramic electronic component, comprising:
a mounting substrate; and
a multilayer ceramic electronic component mounted on the mounting substrate; wherein
the multilayer ceramic electronic component includes:
a multilayer body including a plurality of laminated ceramic layers, a plurality of laminated internal electrode layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction; and
a plurality of external electrodes;
the plurality of internal electrode layers include:
first internal electrode layers alternately laminated with the plurality of ceramic layers and exposed to the first end surface and the second end surface; and
second internal electrode layers alternately laminated with the plurality of ceramic layers and exposed to the first side surface and the second side surface;
the plurality of external electrodes include:
a first external electrode and a second external electrode connected to the first internal electrode layer; and
a third external electrode and a fourth external electrode connected to the second internal electrode layer;
each of the first external electrode and the second external electrode includes a base electrode layer, and the base electrode layer includes a dense region where an area ratio of a conductive component is high and a sparse region where an area ratio of the conductive component is lower than the area ratio of the conductive component of the dense region;
the dense region is located closer to a multilayer body side than the sparse region;
the mounting substrate includes:
a core material of a substrate;
a first connection conductor connected to the first external electrode located on the core material;
a second connection conductor connected to the second external electrode located on the core material;
a third connection conductor connected to the third external electrode located on the core material; and
a fourth connection conductor connected to the fourth external electrode located on the core material; and
in the multilayer ceramic electronic component, the first external electrode and the second external electrode which include the dense region and the sparse region are connected to an anode.

6. A multilayer ceramic electronic component comprising:
a multilayer body including a plurality of laminated ceramic layers, a plurality of laminated internal electrode layers, a first main surface and a second main surface opposing each other in a lamination direction, a first side surface and a second side surface opposing each other in a width direction orthogonal or substantially orthogonal to the lamination direction, and a first end surface and a second end surface opposing each other in a length direction orthogonal or substantially orthogonal to the lamination direction and the width direction; and
a plurality of external electrodes; wherein
the plurality of internal electrode layers include:
first internal electrode layers alternately laminated with the plurality of ceramic layers and exposed to the first end surface and the second end surface; and
second internal electrode layers alternately laminated with the plurality of ceramic layers and exposed to the first side surface and the second side surface;
the plurality of external electrodes include:
a first external electrode and a second external electrode connected to the first internal electrode layer; and
a third external electrode and a fourth external electrode connected to the second internal electrode layer;
each of the third external electrode and the fourth external electrode includes a base electrode layer, and the base electrode layer includes a dense region where an area ratio of a conductive component is high and a sparse region where an area ratio of the conductive component is lower than the area ratio of the conductive component of the dense region; and
the dense region is located closer to a multilayer body side than the sparse region.

7. A mounting structure of a multilayer ceramic electronic component, comprising:
a mounting substrate; and
a multilayer ceramic electronic component mounted on the mounting substrate; wherein
the multilayer ceramic electronic component includes:
a multilayer body including a plurality of laminated ceramic layers, a plurality of laminated internal electrode layers, a first main surface and a second main surface opposing each other in a lamination direction, a first side surface and a second side surface opposing each other in a width direction orthogonal to the lamination direction, and a first end surface and a second end surface opposing each other in a length direction orthogonal to the lamination direction and the width direction; and
a plurality of external electrodes;
the plurality of internal electrode layers include:
first internal electrode layers alternately laminated with the plurality of ceramic layers and exposed to the first end surface and the second end surface; and
second internal electrode layers alternately laminated with the plurality of ceramic layers and exposed to the first side surface and the second side surface;
the plurality of external electrodes include:
a first external electrode and a second external electrode connected to the first internal electrode layer; and
a third external electrode and a fourth external electrode connected to the second internal electrode layer;
each of the third external electrode and the fourth external electrode includes a base electrode layer, and the base electrode layer includes a dense region where an area ratio of a conductive component is high and a sparse region where an area ratio of the conductive component is lower than the area ratio of the conductive component of the dense region;
the dense region is located closer to a multilayer body side than the sparse region;
the mounting substrate includes:
a core material of a substrate;
a first connection conductor connected to the first external electrode located on the core material;
a second connection conductor connected to the second external electrode located on the core material;
a third connection conductor connected to the third external electrode located on the core material; and
a fourth connection conductor connected to the fourth external electrode located on the core material; and
in the multilayer ceramic electronic component, the third external electrode and the fourth external electrode which include the dense region and the sparse region are connected to an anode.

8. The multilayer ceramic electronic component according to claim 1, wherein the first internal electrode layers and the second internal electrode layers respectively include first and second opposing portions and first and second extending portions.

9. The multilayer ceramic electronic component according to claim 8, wherein the first and second extending portions are respectively connected to the first and second external electrodes.

10. The multilayer ceramic electronic component according to claim 1, wherein the base electrode layer includes at least one of a fired layer, a conductive resin layer, and a thin film layer.

11. The mounting structure according to claim 5, wherein the first internal electrode layers and the second internal electrode layers respectively include first and second opposing portions and first and second extending portions.

12. The mounting structure according to claim 11, wherein the first and second extending portions are respectively connected to the first and second external electrodes.

13. The mounting structure according to claim 5, wherein the base electrode layer includes at least one of a fired layer, a conductive resin layer, and a thin film layer.

14. The multilayer ceramic electronic component according to claim 6, wherein the first internal electrode layers and the second internal electrode layers respectively include first and second opposing portions and first and second extending portions.

15. The multilayer ceramic electronic component according to claim 14, wherein the first and second extending portions are respectively connected to the first and second external electrodes.

16. The multilayer ceramic electronic component according to claim 6, wherein the base electrode layer includes at least one of a fired layer, a conductive resin layer, and a thin film layer.

17. The mounting structure according to claim 7, wherein the first internal electrode layers and the second internal electrode layers respectively include first and second opposing portions and first and second extending portions.

18. The mounting structure according to claim 17, wherein the first and second extending portions are respectively connected to the first and second external electrodes.

19. The mounting structure according to claim 7, wherein the base electrode layer includes at least one of a fired layer, a conductive resin layer, and a thin film layer.
